(19) United States
(12) Patent Application Publication
(10) Pub. No.: US 2024/0003119 A1
(43) Pub. Date: Jan. 4, 2024

(54) WORK VEHICLE, CONTROL DEVICE FOR WORK VEHICLE, AND CONTROL METHOD FOR WORK VEHICLE

(71) Applicant: KUBOTA CORPORATION, Osaka-shi (JP)

(72) Inventors: Daiki ABE, Sakai-shi (JP); Ryota HAMAMOTO, Sakai-shi (JP)

(73) Assignee: KUBOTA CORPORATION, Osaka-shi (JP)

(21) Appl. No.: 18/192,641

(22) Filed: Mar. 30, 2023

(30) Foreign Application Priority Data
Jul. 1, 2022 (JP) 2022-106990

(51) Int. Cl. E02F 9/22; G05D 1/02

(52) U.S. Cl. CPC E02F 9/2253; E02F 9/2246; G05D 1/021; G05D 2201/0202

(57) ABSTRACT

A control method for a work vehicle includes acquiring an upper limit speed in a creep mode in which the work vehicle travels at the upper limit speed or less regardless of an operation amount of at least one operation device, detecting a hydraulic pressure in an oil passage between a hydraulic motor to move the work vehicle and a hydraulic pump to actuate the hydraulic motor, determining a traveling primary pressure of pilot oil supplied to an operation valve operated by a first operation device out of the at least one operation device based on a first relationship among the upper limit speed, the hydraulic pressure, and the traveling primary pressure, and controlling a control valve via which the pilot oil is supplied to the operation valve such that a pressure of the pilot oil supplied to the operation valve approaches the traveling primary pressure.

### CROSS-REFERENCE TO RELATED APPLICATIONS

The present application claims priority under 35 U.S.C. § 119 to Japanese Patent Application No. 2022-106990, filed Jul. 1, 2022. The contents of this application are incorporated herein by reference in their entirety.

### BACKGROUND OF THE INVENTION

### Field of the Invention

The present invention relates to a work vehicle, a control device for the work vehicle, and a control method for the work vehicle.

### Discussion of the Background

Japanese Patent Application Laid-Open No. 2017-053413 discloses a technique for measuring an input of a travel lever and rotational speed of a travel motor, and adjusting a pilot pressure of a travel pump so that the rotational speed of the travel motor matches a command based on the input of the travel lever. Japanese Patent Application Laid-Open No. 2020-038002 discloses a method of detecting a primary pressure of pilot oil supplied to a remote control valve and rotational speed of a travel motor, and controlling the primary pressure so as to obtain a target vehicle speed based on the detected primary pressure and rotational speed.

### SUMMARY OF THE INVENTION

According to one aspect of the present disclosure, a control method for a work vehicle includes acquiring an upper limit speed in a creep mode in which the work vehicle travels at the upper limit speed or less regardless of an operation amount of at least one operation device to receive a speed alteration operation from a user. The control method includes detecting a hydraulic pressure in an oil passage between a hydraulic motor to move the work vehicle and a hydraulic pump to actuate the hydraulic motor. The control method includes determining a traveling primary pressure of pilot oil supplied to an operation valve operated by a first operation device out of the at least one operation device based on a first relationship among the upper limit speed, the hydraulic pressure, and the traveling primary pressure. The control method includes controlling a control valve via which the pilot oil is supplied to the operation valve such that a pressure of the pilot oil supplied to the operation valve approaches the traveling primary pressure.

According to another aspect of the present disclosure, a work vehicle includes a hydraulic motor, a hydraulic pump, an oil passage, a hydraulic pressure sensor, at least one operation device, a pilot pump, a pilot oil passage, an operation valve, a control valve, an input device, a memory, and a processor. The hydraulic motor is configured to drive a traveling device. The hydraulic pump is configured to discharge a hydraulic fluid to drive the hydraulic motor. The oil passage connects the hydraulic pump and the hydraulic motor. The hydraulic pressure sensor is configured to detect a hydraulic pressure of hydraulic fluid in the oil passage. The at least one operation device is to receive a speed alteration operation from a user. The at least one operation device includes a first operation device. The pilot pump is configured to discharge pilot oil. The pilot oil passage connects the pilot pump and the hydraulic pump. The operation valve is provided in the pilot oil passage and configured to convert a pressure of the pilot oil from a traveling primary pressure to a traveling secondary pressure according to a first operation amount of the first operation device. The control valve is provided in the pilot oil passage between the pilot pump and the operation valve to convert a pressure of the pilot oil supplied by the pilot pump into the traveling primary pressure. The input device is configured to receive an upper limit speed and to set a creep mode in which the traveling device travels at the upper limit speed or less regardless of an operation amount of the at least one operation device. The memory is configured to store a first relationship among the upper limit speed, the hydraulic pressure of the hydraulic fluid, and the traveling primary pressure. The processor is configured to acquire the upper limit speed from the input device, determine the traveling primary pressure corresponding to the hydraulic pressure detected by the hydraulic pressure sensor and the upper limit speed received by the input device based on the first relationship, and control the control valve such that a pressure of the pilot oil supplied to the operation valve approaches the traveling primary pressure.

According to further aspect of the present disclosure, a control device for a work vehicle includes a processor and a memory. The processor is configured to acquire an upper limit speed in a creep mode in which the work vehicle travels at upper limit speed or less regardless of an operation amount of at least one operation device to receive a speed alteration operation from a user, acquire a hydraulic pressure in an oil passage between a hydraulic motor to move the work vehicle and a hydraulic pump to actuate the hydraulic motor, determine a traveling primary pressure of pilot oil supplied to an operation valve operated by a first operation device out of the at least one operation device based on a first relationship among the upper limit speed, the hydraulic pressure, and the traveling primary pressure, and control a control valve via which the pilot oil is supplied to the operation valve such that a pressure of the pilot oil supplied to the operation valve approaches the traveling primary pressure. The memory is configured to store the first relationship.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 is a side view of a work vehicle.

FIG. 2 is a top view of the work vehicle.

FIG. 3 is a hydraulic circuit diagram of a travel system of the work vehicle.

FIG. 4 is a diagram showing a relationship between engine rotational speed, traveling primary pressure, and a setting line.

FIG. 5 is a diagram showing a relationship between an operating position of an operation lever and a traveling secondary pressure.

FIG. 6 is a block diagram of the work vehicle.

FIG. 7 shows an example of first reference information according to the first embodiment.

FIG. 8 shows an example of second reference information according to the first embodiment.

FIG. 9 shows a method of linear interpolation based on first reference information and second reference information.

FIG. 10 is a flowchart showing the operation of the work vehicle according to the first embodiment.

FIG. 11 shows an example of first reference information according to the second embodiment.

FIG. 12 shows an example of second reference information according to the second embodiment.

FIG. 13 is a flowchart showing an operation of a work vehicle according to a second embodiment.

FIG. 14 is a flowchart showing an operation of a work vehicle according to a third embodiment.

### DESCRIPTION OF THE EMBODIMENTS

Hereinafter, the present invention will be described in detail with reference to the drawings showing embodiments thereof. In the drawings, the same reference numerals denote corresponding or substantially identical configurations.

### First Embodiment

### <Overall Configuration>

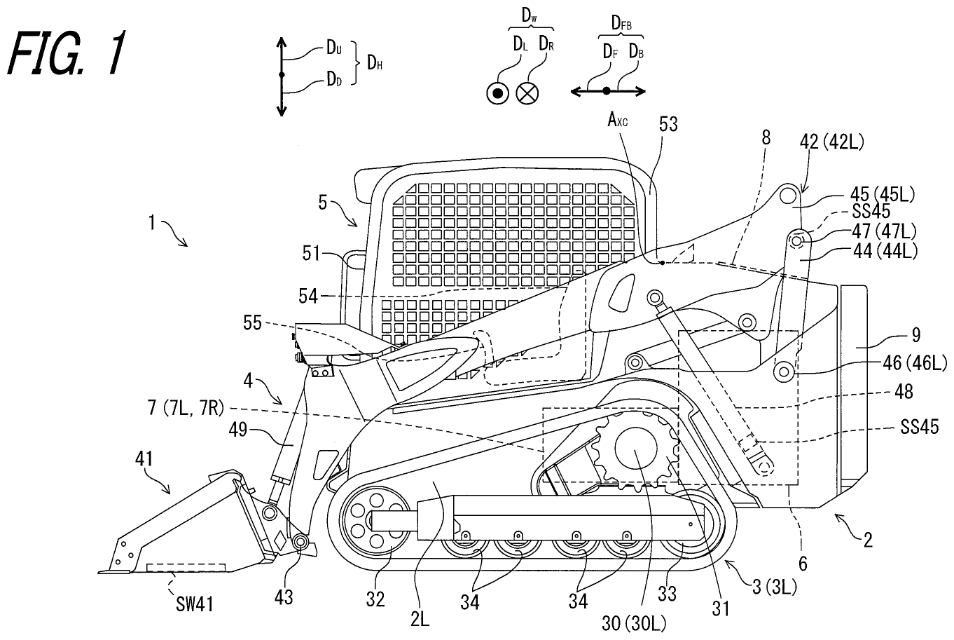

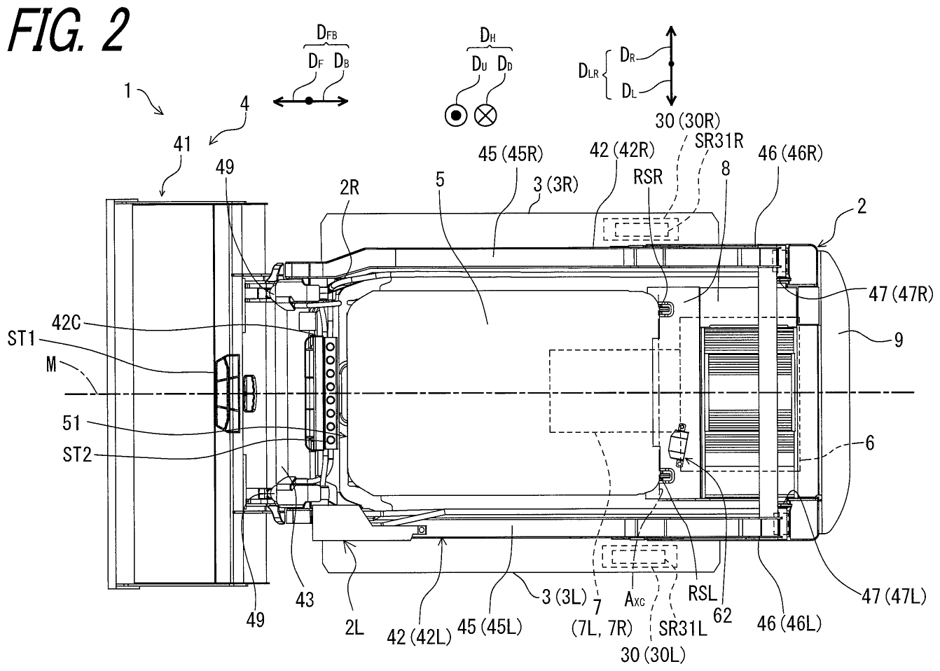

Referring to FIGS. 1 and 2, a work vehicle 1, such as a compact truck loader, includes a vehicle body 2, a pair of traveling devices 3, and a working device 4. The vehicle body 2 supports a traveling device 3 and a working device 4. In the illustrated embodiment, the traveling device 3 is a crawler type traveling device 3. Therefore, each of the pair of traveling devices 3 includes a drive wheel 31 driven by the hydraulic motor device 30, driven wheels 32 and 33, and a rolling wheel 34. However, each of the pair of traveling devices 3 is not limited to the crawler traveling device 3. Each of the pair of traveling devices 3 may be, for example, a front wheel/rear wheel traveling device 3 or a traveling device 3 having a front wheel and a rear crawler. The working device 4 includes a work equipment (bucket) 41 at the distal end of the working device 4. The proximal end of the working device 4 is attached to the rear portion of the vehicle body 2. The working device 4 includes a pair of arm assemblies 42 for rotatably supporting the bucket 41 via a bucket pivot shaft 43. Each of the pair of arm assemblies 42 includes a link 44 and an arm 45.

The link 44 is rotatable with respect to the vehicle body 2 about a fulcrum shaft 46. The arm 45 is rotatable with respect to the link 44 about a joint shaft 47. The working device 4 further includes a plurality of arm cylinders 48 and at least one equipment cylinder 49. Each of the plurality of arm cylinders 48 is rotatably connected to the vehicle body 2 and the arm 45, and moves the link 44, the arm 45 and the like to lift and lower the bucket 41. The at least one equipment cylinder 49 is configured to tilt the bucket 41. The vehicle body 2 includes a cabin 5. The cabin 5 is provided with a front window 51 which can be opened and closed, and an outer shape thereof is defined by a cab frame 53. The front window 51 may be omitted. A work vehicle includes a driver seat 54 and an operation lever 55 in a cabin 5. As shown in FIG. 2, the cab frame 53 is rotatable about rotational shafts RSL and RSR on the vehicle body 2. In FIGS. 1 and 2, a common pivot AXC defined by the rotational shaft RSL and RSR is illustrated. That is, the cab frame 53 is attached to the vehicle body 2 so as to be rotatable about a pivot AXC.

In the embodiment according to the present application, a front-back direction D_{FB} (forward direction DF/backward direction D_{B}) means a front-back direction (forward direction/backward direction) as seen from an operator seated on the driver seat 54 of the cabin 5. A leftward direction D_{L}, a rightward direction D_{R}, a width direction D_{W} means the left direction, the right direction, and the left-right direction as viewed from the operator, respectively. An upward direction D_{U}, a downward direction D_{D}, height direction DH means an upward direction, a downward direction, and a height direction as viewed from the operator. The front-back, left-right (width), and up-down (height) directions of the work vehicle 1 coincide with the front-back, left-right (width), and up-down (height) directions as viewed from the operator, respectively.

FIG. 1 shows the left side of the work vehicle 1. As shown in FIG. 2, the vehicle body 2 is substantially plane-symmetric with respect to the vehicle body center surface M, and is a first side surface 2L which is a left side surface and a second side surface 2R which is a right side face. Among the pair of traveling devices 3, the traveling device 3 provided on the first side surface 2L is shown as the first traveling device 3L, and the traveling device 3 provided on the second side surface 2R is shown as the second traveling device 3R. Among the pair of arm assemblies 42, the arm assembly 42 provided on the left side with respect to the vehicle body center surface M is shown as the first arm assembly 42L, and the arm assembly 42 provided on the right side with respect to the vehicle body center surface M is shown as the second arm assembly 42R. The link 44 provided on the left side of the vehicle body center surface M is shown as a first link 44L. An arm 45 provided on the left side of the vehicle body center surface M is shown as a first arm 45L, and an arm 45 provided on the right side of the vehicle body center surface M is shown as a second arm 45R. The fulcrum shaft 46 provided on the left side of the vehicle body center surface M is shown as the first fulcrum shaft 46L. The fulcrum shaft 46 provided on the right side with respect to the vehicle body center surface M is shown as a second fulcrum shaft 46R. The joint shaft 47 provided on the left side with respect to the vehicle body center surface M is shown as a first joint shaft 47L, and the joint shaft 47 provided on the right side with respect to the vehicle body center surface M is shown as a second joint shaft 47R. Among the hydraulic motor devices 30, the hydraulic motor device 30 provided on the left side with respect to the vehicle body center surface M is shown as the first hydraulic motor device 30L. The hydraulic motor device 30 provided on the right side with respect to the vehicle body center surface M is shown as a second hydraulic motor device 30R.

Referring to FIGS. 1 and 2, the work vehicle 1 includes an engine 6 and provided at a rear portion of the vehicle body 2, and a plurality of hydraulic pumps including the first hydraulic pump 7L and the 2nd hydraulic pump 7R. The engine 6 drives a plurality of hydraulic pumps 7. The first hydraulic pump 7L and the second hydraulic pump 7R are configured to discharge hydraulic fluid for driving a hydraulic motor device 30 for driving the drive wheel 31. The first hydraulic pump 7L and the second hydraulic pump 7R are collectively referred to as hydraulic pumps (7L, 7R). The plurality of hydraulic pumps 7 other than the first hydraulic pump 7L and the second hydraulic pump 7R are configured to discharge hydraulic fluid for driving a hydraulic actuator (a plurality of arm cylinders 48, at least one equipment cylinder 49, or the like) connected to the working device 4. The engine 6 is provided between a pair of arm assemblies 42 in the width direction D_{W} of the work vehicle 1. The work vehicle 1 further includes a cover 8 for covering the engine 6. The work vehicle 1 further includes a bonnet cover 9 provided at the rear end of the vehicle body 2. The bonnet cover 9 is openable and closable such that a maintenance personnel can perform maintenance work on the engine 6 and the like.

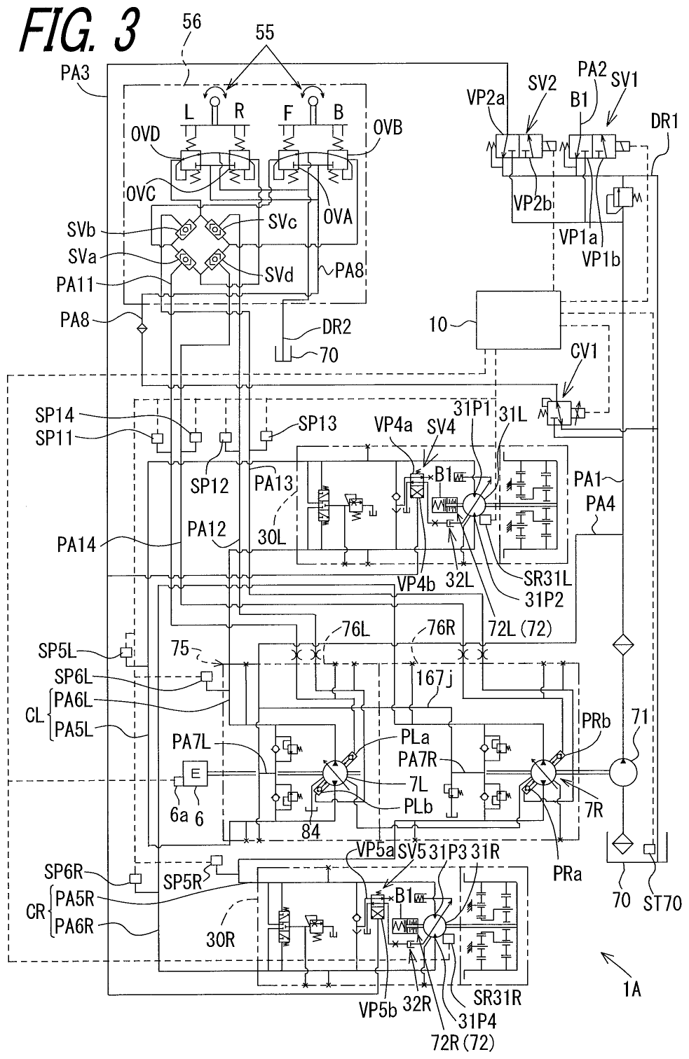

FIG. 3 is a hydraulic circuit diagram of a travel system of the work vehicle 1. The work vehicle includes a hydraulic circuit 1A. The hydraulic circuit 1A includes a hydraulic fluid tank 70 and a pilot pump 71. The pilot pump 71 is a constant displacement gear pump driven by the power of the engine 6. The pilot pump 71 is configured to discharge the hydraulic fluid stored in the hydraulic fluid tank 70. In particular, the pilot pump 71 is configured to discharge a hydraulic fluid mainly used for control. For convenience of explanation, among the hydraulic fluid discharged from the pilot pump 71, the hydraulic fluid used for control is referred to as pilot oil, and the pressure of the pilot oil is referred to as pilot pressure. In particular, the pilot pump 71 is configured to supply pilot oil to a first hydraulic pump 7L and a second hydraulic pump 7R.

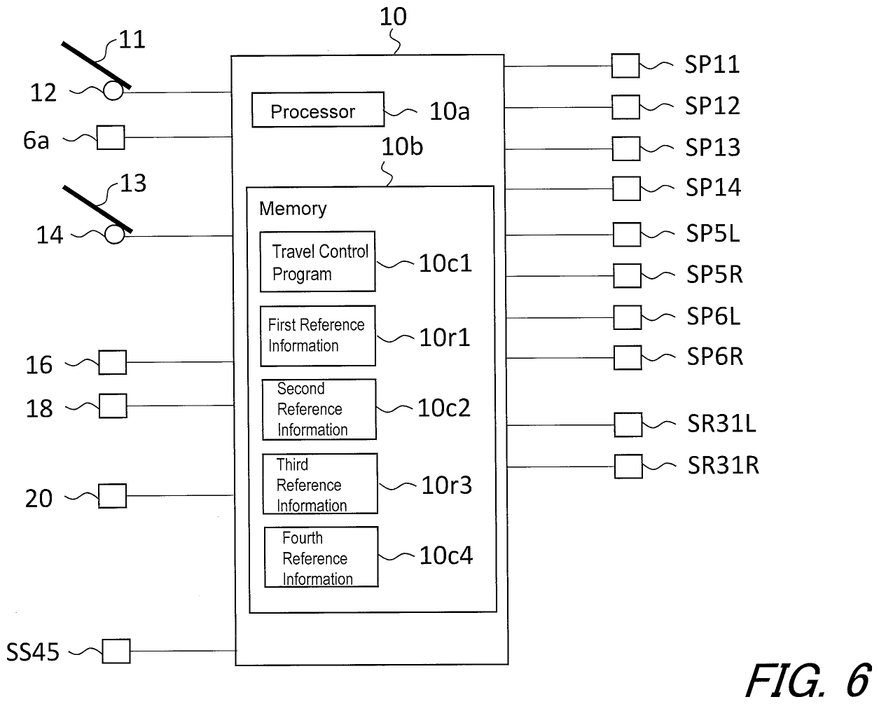

The hydraulic circuit 1A includes a pilot supply oil passage PA1 connected to a discharge port of a pilot pump 71. The pilot oil shall be supplied in the pilot supply oil passage PA1. The hydraulic circuit 1A includes a plurality of switching valves (brake switching valves, direction switching valve SV2) connected to the pilot supply oil passage PA1, and a plurality of brake mechanisms 72. The brake switching valve SV1 is connected to the pilot supply oil passage PAL The brake switching valve SV1 is a direction switching valve (solenoid valve) for braking and releasing braking by the plurality of brake mechanisms 72. The brake switching valve SV1 is a two-position switching valve configured to switch a valve element to the first position VP1a and the second position VP1b by exciting. Switching of the valve element of the brake switching valve SV1 is performed by the brake pedal 13 (see FIG. 6). The brake pedal 13 is provided with a sensor 14. The operation amount detected by the sensor 14 is input to a controller 10 composed of an ECU (Electric Control Unit). The controller 10 may be referred to as a control device.

The plurality of brake mechanisms 72 include a first brake mechanism 72L for braking the first traveling device 3L and a second brake mechanism 72R for braking the second traveling device 3R. The first brake mechanism 72L and the second brake mechanism 72R are connected to the brake switching valve via the oil passage PA2. The first brake mechanism 72L and the second brake mechanism 72R are configured to brake the traveling device 3 according to the pressure of the pilot oil (hydraulic fluid). When the valve element of the brake switching valve SV1 is switched to the first position VP1a, the hydraulic fluid is released from the oil passage PA2 in the section between the brake switching valve SV1 and the brake mechanism 72, and the traveling device 3 is braked by the brake mechanism 72. When the valve element of the brake switching valve SV1 is switched to the second position VP1b, the braking by the brake mechanism 72 is released. When the valve element of the brake switching valve SV1 is switched to the first position VP1a, the braking by the brake mechanism 72 is released, and when the valve element of the brake switching valve SV1 is switched to the second position VP1b, the traveling device 3 may be braked by the brake mechanism 72.

The direction switching valve SV2 is an electromagnetic valve for changing the rotation of the first hydraulic motor device 30L and the second hydraulic motor device 30R. The direction switching valve SV2 is a two-position switching valve configured to switch a valve element to the first position VP2a or second position VP2b by excitation. Switching of the direction switching valve SV2 is performed by an operating member (not illustrated) or the like. The direction switching valve SV2 may be a proportional valve capable of adjusting the flow rate of the hydraulic fluid to be discharged, instead of a two-position switching valve.

The first hydraulic motor device 30L is a device for transmitting power to drive wheels 31 provided in the first traveling device 3L. The first hydraulic motor device 30L includes a first hydraulic motor 31L, a first swash plate switching cylinder 32L, and a first travel control valve (hydraulic switching valve) SV4. The first hydraulic motor 31L is a swash plate type variable capacity axial motor for driving the first traveling device 3L, and is a motor capable of changing the vehicle speed (rotation) to a first speed or a second speed. The first swash plate switching cylinder 32L is configured to change the angle of the swash plate of the first hydraulic motor 31L by expansion and contraction. The first travel control valve SV4 expands and contracts the first swash plate switching cylinder 32L. The first travel control valve SV4 is a two-position switching valve configured to switch its valve element between the first position VP4a and the second position VP4b.

Switching of the first travel control valve SV4 is performed by a direction switching valve SV2 located on the upstream side and connected to the first travel control valve SV4. Specifically, the direction switching valve SV2 and the first travel control valve SV4 is connected by the oil passage PA3 and the switching operation of the first travel control valve SV4 is performed by hydraulic fluid flowing through the oil passage PA3. For example, the valve element of the direction switching valve SV2 is switched to the first position VP2a, the pilot oil is released in the section between the direction switching valve SV2 and the first travel control valve SV4, and the valve element of the first travel control valve SV4 is switched to the first position VP4a. As a result, the first swash plate switching cylinder 32L contracts, and the speed of the first hydraulic motor 31L is changed to the first speed. When the valve element of the direction switching valve SV2 is switched to the second position VP2b by the operation of the operating member, the pilot oil is supplied to the first travel control valve SV4 through the direction switching valve SV2, and the valve element of the first travel control valve SV4 is switched to the second position VP4b. As a result, the first swash plate switching cylinder 32L is extended, and the speed of the first hydraulic motor 31L is changed to the second speed.

The second hydraulic motor device 30R transmits power to the drive wheels 31 provided in the second traveling device 3R. The second hydraulic motor device 30R includes a second hydraulic motor device 30R, a second hydraulic motor 31R, a second swash plate switching cylinder 32R, and a second travel control valve (hydraulic switching valve). The second hydraulic motor device 30R is a hydraulic motor for driving the second traveling device 3R, and operates similarly to the first hydraulic motor device 30L. That is, the second hydraulic motor 31R operates in the same manner as the first hydraulic motor 31L. The first hydraulic motor 31L and the second hydraulic motor 31R are collectively referred to as hydraulic motors (31L, 31R). The second swash plate switching cylinder 32R operates in the same manner as the first swash plate switching cylinder 32L. The second travel control valve SV5 is a two-position switching valve configured to switch its valve element between the first position VP5a and the second position VP5b, and operates in the same manner as the first travel control valve SV4.

A drain oil passage DR1 is connected to the hydraulic circuit 1A. The drain oil passage DR1 is an oil passage to make the pilot oil flow from a plurality of the switching valves (a brake switching valve SV1 and a direction switching valve SV2) to the hydraulic fluid tank 70. For example, the drain oil passage DR1 is connected to a discharge port of a plurality of switching valves (a brake switching valve SV1 and a direction switching valve SV2). That is, when the brake switching valve SV1 is at the first position VP1a, the hydraulic fluid is discharged from the oil passage PA2 to the drain oil passage DR1 in the interval between the brake switching valve SV1 and the brake mechanism 72. When the direction switching valve SV2 is located at the first position VP1a, the pilot oil in the oil passage PA3 is discharged to the drain oil passage DR1.

The hydraulic circuit 1A further includes a first charge oil passage PA4 and a hydraulic drive device 75. The first charge oil passage PA4 is branched from the pilot supply oil passage PA1 and connected to the hydraulic drive device 75. The hydraulic drive device 75 drives the first hydraulic motor device 30L and the second hydraulic motor device 30R. The hydraulic drive device 75 includes a first drive circuit 76L for driving the first hydraulic motor device 30L and a second drive circuit 76R for driving the second hydraulic motor device 30R.

The first drive circuit 76L includes the first hydraulic pump 7L, a drive oil passage PA5L, PA6L, and a second charge oil passage PA7L. The driving oil passages PA5L and PA6L are oil passages for connecting the first hydraulic pump 7L and the first hydraulic motor 31L. The hydraulic circuit formed by the driving oil passages PA5L and PA6L is referred to as a first hydraulic circuit CL. The second charge oil passage PA7L, which is connected to the drive oil passages PA5L and PA6L, is an oil passage for replenishing the drive oil passages PA5L and PA6L with the hydraulic fluid from the pilot pump 71. The first hydraulic motor 31L has a first connection port 31P1 connected to the drive oil passage PA5L and a second connection port 31P2 connected to the drive oil passage PA6L. The hydraulic fluid for rotating the first traveling device 3L in the backward direction is inputted to the first hydraulic motor 31L) via the first connection port 31P1, and the hydraulic fluid for rotating the first traveling device 3L in the forward direction is discharged from the first hydraulic motor 31L via the first connection port 31P1. The hydraulic fluid for rotating the first traveling device 3L in the backward direction is input to the first hydraulic motor 31L) via the second connection port 31P2, and hydraulic fluid for rotating the first traveling device 3L in the forward direction is discharged from the first traveling device 3L.

Similarly, the second drive circuit 76R includes a second hydraulic pump 7R, a drive oil passages PA5R and PA6R, and a third charge oil passage PA7R. The drive oil passages PA5R and PA6R are oil passages connecting the second hydraulic pump 7R and the second hydraulic motor 31R. The hydraulic circuit formed by the drive oil passages PA5R and PA6R is referred to as the second hydraulic circuit CR. The third charge oil passage PA7R is an oil passage which is connected to the drive oil passages PA5R and PA6R and replenishes the drive oil passages PA5R and PA6R with the hydraulic fluid from the pilot pump 71. The second hydraulic motor 31R includes a third connection port 31P3 connected to the drive oil passage PA5R, and a fourth connection port 31P4 connected to the drive oil passage PA6R. The hydraulic fluid for rotating the second traveling device 3R in the forward direction is input to the second hydraulic motor 31R via the third connection port 31P3, and the hydraulic fluid for rotating the second traveling device 3R in the backward direction is discharged from the second hydraulic motor 31R via the third connection port 31P3. The hydraulic fluid for rotating the second traveling device 3R in the backward direction is input to the second hydraulic motor 31R via the fourth connection port 31P4, and the hydraulic fluid for rotating the second traveling device 3R in the forward direction is discharged from the second traveling device 3R. That is, the hydraulic motors 31L, 31R are configured to drive the traveling devices 3L, 3R. The hydraulic pumps 7L, 7R are configured to discharge hydraulic fluid for driving hydraulic motors 31L, 31R. The drive oil passages (PA5L, PA6L, PA5R, PA6R) are oil passages that connect hydraulic pumps 7L, 7R and hydraulic motors 31L, 31R.

The first hydraulic pump 7L and the second hydraulic pump 7R are swash plate type variable capacity axial pump which is driven by the power of the engine 6. The first hydraulic pump 7L which is connected to a first hydraulic motor 31L via a first hydraulic circuit CL includes a first port PLa and a second port PLb to which a pilot pressure acts. The angle of the swash plate in the first hydraulic pump 7L is changed by the pilot pressure acting on the first port PLa and the second port PLb. Specifically, the first hydraulic pump 7L supplies hydraulic fluid to a first hydraulic motor 31L via a first hydraulic circuit CL so as to drive a first traveling device 3L forward when the hydraulic pressure applied to a second port PLb is higher than the hydraulic pressure applied to a first port PLa, and hydraulic fluid is supplied to the first hydraulic motor 31L via a first hydraulic circuit CL so as to drive the first traveling device 3L backward when the hydraulic pressure applied to a second port PLb is higher than the hydraulic pressure applied to a first port PLa.

The second hydraulic pump 7R which is connected to the second hydraulic motor 31R via the second hydraulic circuit CR, includes a third port PRa and a fourth port PRb to which the pilot pressure acts. Specifically, the second hydraulic pump 7R is configured such that when the hydraulic pressure applied to the third port PRa is higher than the hydraulic pressure applied to the fourth port PRb, the second hydraulic pump 7R supplies hydraulic fluid to the second hydraulic motor 31R via a second hydraulic circuit CR so as to drive the second traveling device 3R forward, and when the hydraulic pressure applied to the fourth port PRb is higher than the hydraulic pressure applied to the third port PRa, the second hydraulic pump 7R supplies hydraulic fluid to the second hydraulic motor 31R via a second hydraulic circuit CR so as to drive the second traveling device 3R backward. The first hydraulic pump 7L and the second hydraulic pump 7R can change the output (discharge amount of the hydraulic fluid) and the discharge direction of the hydraulic fluid in accordance with the angle of the swash plate.

The output of the first hydraulic pump 7L and the second hydraulic pump 7R and the discharge direction of the hydraulic fluid are changed by an operation device 56 for operating the traveling direction of the work vehicle 1. Specifically, the outputs of the first hydraulic pump 7L and the second hydraulic pump 7R and the discharge direction of the hydraulic fluid are changed according to the operation of the operation lever 55 provided in the operation device 56. That is, the operation device 56 is a device configured to select at least one of the first traveling device 3L and the second traveling device 3R, and to operate the traveling direction of the work vehicle by instructing at least one of the traveling devices to move forward or backward.

As shown in FIG. 3, the hydraulic circuit 1A includes as pilot supply passage PA8 which is branched from the pilot supply oil passage PA1 and connected to the operation device 56, and a pilot pressure control valve CV1 provided on a pilot supply oil passage PA8. The pilot pressure control valve CV1 is an electromagnetic proportional valve and is configured to adjust the pilot pressure supplied to the operation device 56 by adjusting the opening thereof. The opening degree of the pilot pressure control valve CV1 is controlled by the controller 10. In the following embodiments, the pilot pressure control valve CV1 may be referred to as a hydraulic pressure adjusting mechanism. The detailed operation of the pilot pressure control valve CV1 will be described later.

The operation device 56 includes can operation valve OVA for forward movement, an operation valve OVB for backward movement, an operation valve OVC for right turning, an operation valve OVD for left turning, and an operation lever 55. The operation device 56 has first to fourth shuttle valves SVa, SVb, SVc, and SVd. The operation valves OVA, OVB, OVC, and OVD are operated by a single operation lever 55. The operation valves OVA, OVB, OVC, and OVD change the pressure of the hydraulic fluid in accordance with the operation of the operation lever 55, and the changed hydraulic fluid is transferred to the first port PLa and the second port PLb of the first hydraulic pump 7L and the third port PRa and the fourth port PRb of the second hydraulic pump 7R. Although the operation valves OVA, OVB, OVC, and OVD are operated by one operation lever 55 in this embodiment, a plurality of operation levers 55 may be used. In the following embodiments, one or a plurality of operation lever s 55 may be referred to as a first operation device.

Each of the operation valves OVA, OVB, OVC, and OVD has an input port (primary port), an discharge port, and an output port (secondary port). As shown in FIG. 3, the input port is connected to the pilot supply oil passage PA8. The discharge port is connected to the drain oil passage D which goes to hydraulic fluid tank 70. The operation lever 55 can be tilted in a forth and back direction, width direction orthogonal to forth and back, and an oblique direction from the neutral position. In response to the tilt of the operation lever 55, the operation valve OVA, OVB, OVC and OVD of the operation device 56 are operated. Thus, the pilot pressure corresponding to the operation amount of the operation lever 55 from the neutral position is output from the secondary ports of the operation valves OVA, OVB, OVC, and OVD. The relationship between the pilot pressure applied to the primary port outputted from the pilot pressure control valve CV1 and the pilot pressure applied to the secondary port will be described later.

A secondary port of the operation valve OVA and a secondary port of the operation valve OVC are connected to an input port of a first shuttle valve SVa, and an output port of the first shuttle valve SVa is connected to a first port PLa of a first hydraulic pump 7L via a first pilot oil passage PA11. A secondary port of the operation valve OVA and a secondary port of the operation valve OVD are connected to an input port of a second shuttle valve SVb, and an output port of the second shuttle valve SVb is connected to a third port PRa of a second hydraulic pump 7R via a third pilot oil passage PA13. A secondary port of the operation valve OVB and a secondary port of the operation valve OVD are connected to an input port of a third shuttle valve SVc, and an output port of the third shuttle valve SVc is connected to a second port PLb of a first hydraulic pump 7L via a second pilot oil passage PA12. A secondary port of the operation valve OVB and a secondary port of the operation valve OVC are connected to an input port of a fourth shuttle valve SVd, and an output port of the fourth shuttle valve SVd is connected to a fourth port PRb of a second hydraulic pump 7R via a fourth pilot oil passage PA14. That is, the pilot supply oil passage PA8, the first pilot oil passage PA11 and the fourth pilot oil passage PA14 connect the pilot pump 71 and the first hydraulic pump 7L. The pilot supply oil passage PA8, the second pilot oil passage PA12, and the third pilot oil passage PA13 connect the pilot pump 71 and the second hydraulic pump 7R.

When the operation lever 55 is tilted to the front side, the forward operation valve OVA is operated and the pilot pressure is output from the operation valve OVA. This pilot pressure acts on the first port PLa from the first shuttle valve SVa via the first pilot oil passage PA11 connecting the operation device 56 and the first port PLa of the first hydraulic pump 7L, and also acts on the third port PLa from the second shuttle valve SVb via the third pilot oil passage PA13 connecting the operation device 56 and the third port PRa of the second hydraulic pump 7R. As a result, the output shaft of the first hydraulic pump 7L and the output shaft of the second hydraulic pump 7R rotate forward (forward rotation) at a speed corresponding to the tilt amount of the operation lever 55, and the work vehicle 1 moves straight forward.

When the operation lever 55 is tilted rearward, the operation valve OVB for the backward movement is operated, and pilot pressure is output from the operation valve OVB. This pilot pressure acts on the second port PLb of the first hydraulic pump 7L via the second pilot oil passage PA12 connecting the operation device 56 and the second port applied from the third shuttle valve SVc and also acts on the fourth port PRb via the fourth pilot oil passage PA14 connecting the operation device 56 and the fourth port PRb of the second hydraulic pump 7R. As a result, the output shaft of the first hydraulic pump 7L and the output shaft of the second hydraulic pump 7R are rotated reversely (backward rotation) at a speed corresponding to the tilt amount of the operation lever 55, and the work vehicle 1 moves straight backward.

When the operation lever 55 is tilted to the right side, the operation valve OVC for turning right is operated, and the pilot pressure is output from the operation valve OVC. This pilot pressure acts on the first port PLa of the first hydraulic pump 7L via the first pilot oil passage PA11 from the first shuttle valve SVa, and acts on the fourth port PRb of the second hydraulic pump 7R via the fourth pilot oil passage PA14 of the fourth shuttle valve SVd. Thereby, the operation lever 55 moves curvedly to the right with the degree of bending corresponding to the operation position.

Also, when the operation lever 55 is tilted to the left side, the operation valve OVD for turning to the left is operated, and the pilot pressure is output from the operation valve OVD. This pilot pressure acts on the third port PRa of the second hydraulic pump 7R from the second shuttle valve SVb via the third pilot oil passage PA13, and acts on the second port PLb of the first hydraulic pump 7L from the third shuttle valve SVc via the second pilot oil passage PA12. As a result, the operation lever 55 moves curvedly to the left with a degree of bending corresponding to the operation position.

That is, when the operation lever 55 is tilted to the front side obliquely to the left, the work vehicle 1 advances at a speed corresponding to the operation position of the operation lever 55 in the front-rear direction, and bends to the left at a degree of bending corresponding to the operation position of the operation lever 55 in the left direction. When the operation lever 55 is tilted to the front side obliquely to the right, the work vehicle 1 rotates to the right while the right at a speed corresponding to the operating position of the operation lever 55. When the operation lever 55 is tilted to the left obliquely rearward, the work vehicle 1 turns to the left while moving backward at a speed corresponding to the operating position of the operation lever 55. When the operation lever 55 is tilted to the rear side obliquely to the right, the work vehicle 1 rotates to the right while moving backward at a speed corresponding to the operation position of the operation lever 55.

Next, the detailed operation of the pilot pressure control valve CV1 will be described. The work vehicle 1 includes a setting member 11 (see FIG. 6) for setting a target rotational speed of the engine 6. The setting member 11 is an accelerator pedal which is a speed input device different from the operation device 56 described above, a swingably supported accelerator lever, or a turnable indoor dial. The setting member 11 is provided with a sensor 12. The operation amount detected by the sensor 12 is input to the controller 10. The engine rotational speed corresponding to the operation amount detected by the sensor 12 is the target rotational speed of the engine 6. In other words, the target rotational speed of the engine 6 is set based on the operation amount of the setting member 11. The controller 10 outputs a rotation command indicating, for example, a fuel injection amount, an injection timing, and a fuel injection rate to the injector in order to become the target rotational speed of the engine 6 as determined. Alternatively, the controller 10 outputs a rotation command indicating the fuel injection pressure or the like to the supply pump or the common rail in order to become the target rotational speed of the engine 6 as determined. In the following embodiments, the one or more operation levers 55 and the setting member 11 described above may be referred to as at least one operation device 56. A speed sensor 6a for detecting an actual engine rotational speed (referred to as an actual rotational speed of the engine 6) is connected to the controller 10, and the actual rotational speed of the engine 6 is input to the controller 10. The speed sensor 6a is, for example, a potentiometer configured to detect the rotational speed of a rotating member connected to the crankshaft of the engine 6. When a load is applied to the engine 6, the actual rotational speed of the engine 6 is reduced from the target rotational speed of the engine 6. Decrease amount of the actual rotational speed from the target rotational speed when a load is applied to the engine 6 from the target rotational speed (the difference between the target rotational speed of the engine and the actual rotational speed of the engine) is referred to as a drop amount of the engine.

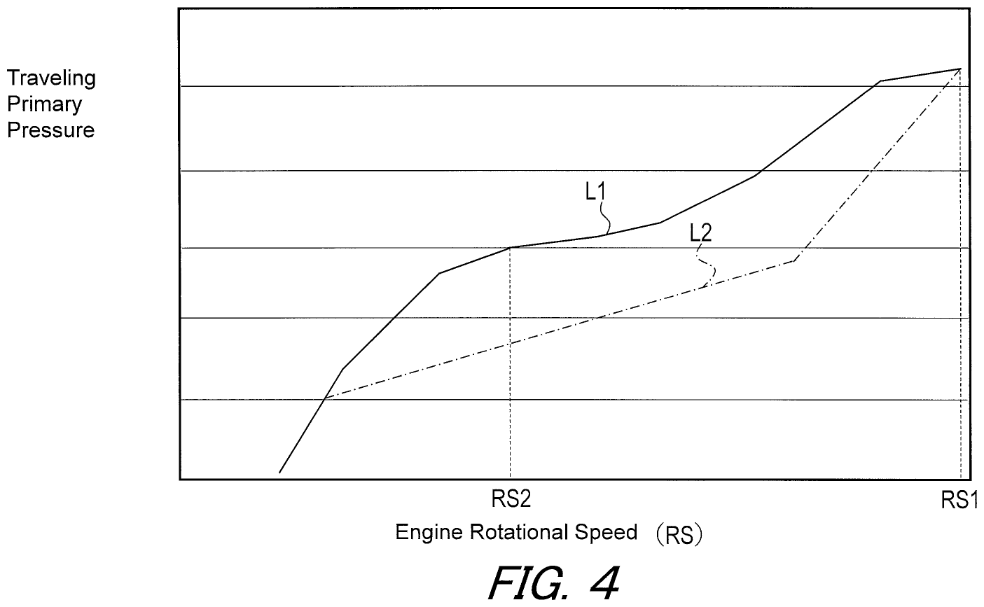

The pilot pressure control valve CV1 can set a pilot pressure (primary pilot pressure) acting on the input ports (primary ports) of the operation valves OVA, OVB, OVC, and OVD based on a decrease amount (drop amount) ΔE1 of the rotational speed (engine rotational speed E1) of the engine 6. In other words, the pilot pressure control valve CV1 is a control valve provided between the pilot pump 71 and the operation valves OVA, OVB, OVC, and OVD and configured to feed pilot oil to the operation valves OVA, OVB, OVC, and OVD and to convert the pressure of the pilot oil supplied to the operation valves OVA, OVB, OVC, and OVD into primary pilot pressure. The rotational speed of the engine 6 can be detected by the speed sensor 6a of the engine rotational speed E1. The engine rotational speed E1 detected by the speed sensor 6a is input to the controller 10. The speed sensor 6a may be referred to as speed sensor 6a. FIG. 4 shows the relationship among the engine rotational speed, the traveling primary pressure (primary pilot pressure), and the setting lines L1 and L2. The setting line L1 shows the relationship between the engine rotational speed E1 when the decrease amount ΔE1 is less than a predetermined value (less than the anti-stall determination value) and the traveling primary pressure. The setting line L2 shows the relationship between the engine rotational speed E1 when the decrease amount ΔE1 is equal to or greater than the anti-stall determination value and the traveling primary pressure. When the difference between the rotational speed RS determined based on the operation amount of the setting member 11 and the actual rotational speed of the engine 6 is smaller than a predetermined stall determination speed difference (anti-stall determination value), the primary pilot pressure corresponding to the rotational speed RS changes according to the third relationship indicated by the setting line L1. When the difference between the rotational speed RS and the actual rotational speed of the engine 6 is equal to or greater than a predetermined stall determination speed difference (anti-stall determination value), the primary pilot pressure corresponding to the rotational speed RS changes according to the fourth relationship shown in the setting line L2.

When the decrease amount ΔE1 is less than the anti-stall determination value, the controller 10 adjusts the opening of the pilot pressure control valve CV1 so that the relationship between the engine rotational speed E1 and the traveling primary pressure matches the reference pilot pressure indicated by the setting line L1. When the decrease amount ΔE1 is equal to or greater than the anti-stall determination value, the controller 10 adjusts the opening of the pilot pressure control valve CV1 so that the relationship between the engine rotational speed E1 and the traveling primary pressure coincides with the setting line L2 lower than the reference pilot pressure. At the setting line L2, the traveling primary pressure for a predetermined engine rotational speed E1 is lower than the traveling primary pressure at the setting line L1. That is, when attention is paid to the same engine rotational speed E1, the traveling primary pressure of the setting line L2 is set lower than the traveling primary pressure of the setting line L1. Therefore, by the control based on the setting line L2, the pressure (pilot pressure) of the hydraulic fluid entering the operation valves OVA, OVB, OVC, and OVD is suppressed to be low. As a result, the angle of the swash plate of the first hydraulic pump 7L and the second hydraulic pump 7R is adjusted, the load acting on the engine 6 is reduced, and stalling of the engine 6 can be prevented. Although FIG. 4 shows one setting line L2, a plurality of setting lines L2 may be provided. For example, the setting line L2 may be set for each engine rotational speed E1. Further, it is preferable that the controller 10 has data indicating the setting line L1 and the setting line L2, control parameters such as functions, and the like.

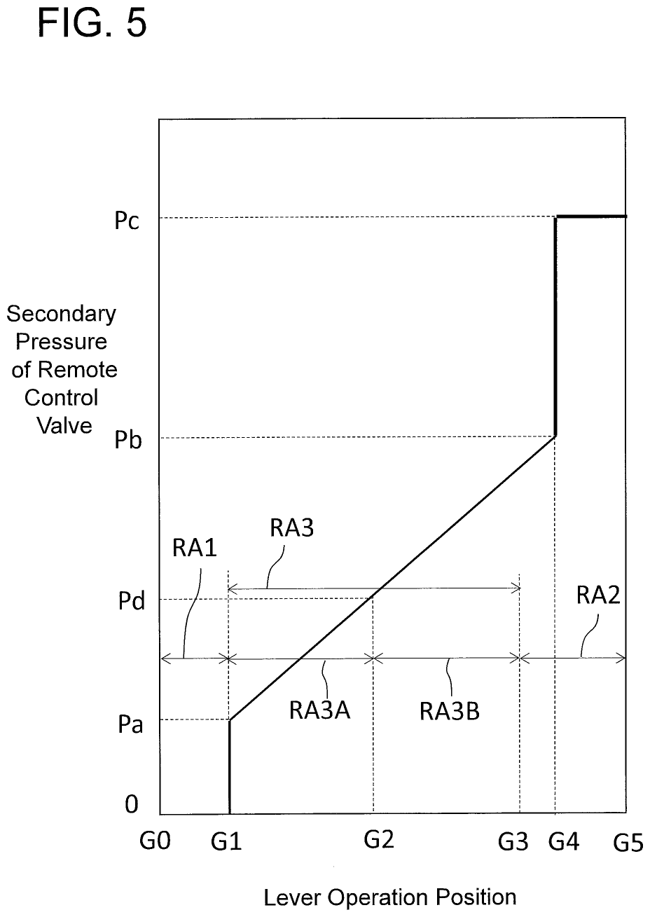

Secondly, the following describes the secondary pilot pressure output from the secondary port of the operation valves OVA, OVB, OVC, OVD. FIG. 5 is a diagram showing the relationship between the operating position of the operation lever and the traveling secondary pressure (secondary pilot pressure). Referring to FIG. 4, the lever operation position is an operation start position (neutral position, G0 position) in which the origin is the start position of the lever stroke, and approaches the operation end position (G5 position) in which the end position of the lever stroke is the operation end position (0 position) as the lever operation position is away from the origin. The operation area of the operation lever 55 is divided into a neutral area RA1 in which the operation target does not operate (from the G0 position to the G1 position in the drawings), a near full-operation area RA2 near the operation end (from the G3 position to the G5 position in the drawings), and an intermediate area RA3 between the neutral area RA1 and the near full-operation area RA2 (from the G1 position to the G3 position in the drawings). The intermediate area RA3 is further divided into a slow speed area RA3A extending from the G1 position to the G2 position and an intermediate speed area RA3B extending from the G2 position to the G3 position.

In the neutral area RA1, the secondary pilot pressure is not supplied even if the operation lever 55 is operated. On the other hand, in the near full-operation area RA2, the speed of the operation target is not adjusted, so that the operation lever 55 is operated to the operation end position (G5 position) without stopping in the middle. In the intermediate area RA3, the operation lever 55 is stopped at an arbitrary position within the area or the position thereof is changed so that the speed of the operation target becomes the speed desired by the operator. For example, the ratios of the operation areas RA1, RA3A, RA3B and RA2 to the lever stroke are as follows.
Neutral area RA1: 0% or more and less than 15%
Slow speed range RA3A: 15% or more and less than 45%
Intermediate speed area RA3B: 45% or more and less than 75%
Near full-operation area RA2: 75% to 100%

In the characteristic diagram shown in FIG. 5, when the operation lever 55 is operated from the G0 position to the G1 position, a secondary pilot pressure (Pa) is generated, and when the operation lever 55 is operated from the G1 position to the G4 position, the secondary pilot pressure increases from Pa to Pb in proportion to the operation amount of the operation lever 55. Then, at position G4, the primary pilot pressure is short-cut and flows to the secondary side, and the secondary pilot pressure rises from Pb to the maximum output pressure Pc at once. While the operation lever 55 is operated from the G4 position to the G5 position, the secondary pilot pressure is constant at the maximum output pressure (Pc) and becomes equal to the primary pilot pressure. That is, the operation device 56 outputs the primary pilot pressure input to the operation device 56 to the first port PLa and the fourth port PRb when the displacement of the operation lever 55 for instructing movement in the leftward direction from the neutral position is equal to or greater than the first displacement value (the displacement from G0 to G4). The operation device 56 outputs the primary pilot pressure input to the operation device 56 to the second port PLb and the third port PRa when the displacement of the operation lever 55 for instructing movement in the right direction from the neutral position is equal to or greater than a first displacement value (displacement from G0 to G4). The operation device 56 outputs the primary pilot pressure input to the operation device 56 to the first port PLa and the third port PRa when the displacement of the operation lever 55 for instructing movement in the forward direction from the neutral position is equal to or greater than a first displacement value (displacement from G0 to G4). The operation device 56 outputs the primary pilot pressure input to the operation device 56 to the second port PLb and the fourth port PRb when the displacement of the operation lever 55 for instructing movement in the backward direction from the neutral position is equal to or greater than a first displacement value (displacement from G0 to G4). The characteristic value of the longitudinal secondary pilot pressure may be different from the characteristic value of the lateral secondary pilot pressure. Assuming that the characteristic values of the longitudinal secondary pilot pressures corresponding to G0 to G5 and Pa to Pc are G0′ to G5′ and Pa′ to Pc, the operation device 56 may output the primary pilot pressure input to the operation device 56 to the first port PLa and the third port PRa when the displacement of the operation lever 55 for instructing movement in the forward direction from the neutral position is equal to or greater than a second displacement value (displacement from G0′ to G4′). The operation device 56 may output the primary pilot pressure input to the operation device 56 to the second port PLb and the fourth port PRb when the displacement of the operation lever 55 for instructing movement in the rearward direction from the neutral position is equal to or greater than the second displacement value (the displacement from G0′ to G4′). In addition, Pa and Pb (Pa′ and Pb′) are values independent of the magnitude of the primary pilot pressure, but when the primary pilot pressure is lower than Pa or Pb (Pa′ or Pb′), the secondary pilot pressure reaches a plateau at the magnitude of the primary pilot pressure. That is, the operation valves (OVA, OVB, OVC, OVD) are configured to convert the pressure of the pilot oil from the traveling primary pressure to the traveling secondary pressure in accordance with the first operation amount (operation lever position) of the operation device 56, and output the pilot oil. The pilot oil at traveling secondary pressure is applied to ports (PLa, PRa, PLb, PRb) that provide hydraulic pressure to swash plate of hydraulic pumps (7L, 7R). When the first operation amount is equal to or greater than the threshold amount (first displacement value), the operation valves (OVA, OVB, OVC, OVD) are converted into a traveling secondary pressure equal to the traveling primary pressure.

Based on the features of the operation valves OVA, OVB, OVC and OVD described above, the movement of the work vehicle 1 corresponding to the operation of the operation lever 55 will be described in more detail. When an operation amount of the operation lever in the front-rear direction is larger than an operation amount of the operation lever 55 in the right direction, and the operation position of the operation lever 55 in the right direction is operated from the G1 position to the G3 position, the work vehicle bends to the right in a large circle by rotating in the same direction in a state in which the magnitude of the rotational speed of the first hydraulic pump 7L is larger than the magnitude of the rotational speed of the second hydraulic pump 7R. When the operation position of the operation lever in the right direction becomes the same position as the operation position in the front-rear direction, the rotational speed of the second hydraulic pump 7R becomes 0, and only the first hydraulic pump 7L rotates, whereby the work vehicle 1 makes a right pivotal turn (right pivot turn). In addition, when the operation position of the operation lever 55 in the right direction is operated between the G4 position and the G5 position, the output shaft of the first hydraulic pump 7L rotates in the forward direction and the output shaft of the second hydraulic pump 7R rotates in the reverse direction so that the work vehicle 1 turns to the right side.

Further, when the operation amount in the front-rear direction of the operation lever 55 is larger than the operation amount in the left direction and the operation position of the operation lever 55 in the left direction is operated from the G1 position to the G3 position, the work vehicle bends to the left in a large turn by rotating in the same direction with the magnitude of the rotational speed of the second hydraulic pump 7R being larger than the magnitude of the rotational speed of the first hydraulic pump 7L. When the operation position of the operation lever 55 in the left direction becomes the same position as the operation position in the front-rear direction, the rotational speed of the first hydraulic pump 7L becomes 0, and only the second hydraulic pump 7R rotates, so that the work vehicle 1 makes a left pivotal turn (left pivot turn). Further, when the operating position of the operation lever 55 in the leftward direction is operated between the G4 position and the G5 position, the operating position becomes larger than the operating position in the front-rear direction, the output shaft of the second hydraulic pump 7R rotates in the forward direction and the output shaft of the first hydraulic pump 7L rotates in the reverse direction, so that the work vehicle turns to the left. In the present embodiment, the turning means the movement of the work vehicle 1 when the operation position to the right is operated between the G4 position and the G5 position, or when the operation position to the left is operated between the G4 position and the G5 position.

On the other hand, when the operating position in the forward direction of the operation lever 55 is operated between the G4 position and the G5 position, the operating position becomes larger than the operating position in the left-right direction, the output shafts of the first hydraulic pump 7L and the second hydraulic pump 7R rotate in the forward direction, and the work vehicle advances at high speed. When the operating position of the operation lever 55 in the backward direction is operated between the G4 position and the G5 position, the operating position becomes larger than the operating position in the left-right direction, the output shafts of the first hydraulic pump 7L and the second hydraulic pump 7R are inverted, and the work vehicle 1 moves backward at high speed. The operation of the operation lever 55 in the front-rear direction is the same as that in the left-right direction.

The work vehicle 1 includes various switches and sensors connected to the controller 10 described above. FIG. 6 is a block diagram of the work vehicle 1. Referring to FIG. 6, the work vehicle 1 includes a creep setting member 16 provided around the driver seat 54. The creep setting member 16 may be referred to as an input device. The creep setting member 16 is provided with, for example, a touch panel, a slidable slide-type switch, or a dial. Creep is to control for running the work vehicle 1 at an upper limit speed or less regardless of the operation amount of at least one operation device 56 (the setting member 11, one or a plurality of operation levers 55) to which the user's speed alteration operation is input. The upper limit speed is input by the creep setting member 16. The creep setting member 16 is configured so as to switch between the normal mode and the creep mode. A state in which the upper limit speed is set by the creep setting member 16 is referred to as a creep mode. The state other than the creep mode is referred to as the normal mode.

In the normal mode, the target rotational speed of the engine 6 is set by the operation of the setting member 11, and the traveling primary pressure corresponding to the target rotational speed is obtained based on the setting line L1 or L2 in FIG. 4. The traveling secondary pressure is set based on the operation amount of one or a plurality of operation levers 55, and the hydraulic motors (31L, 31R) and hydraulic pumps (7L, 7R) are controlled. That is, in the normal mode, it is possible to change the speed of the work vehicle 1 in accordance with the operation amount of at least one operation device, and to run the work vehicle 1 at a speed higher than the upper limit speed. On the other hand, in the creep mode, the setting line L1 or L2 in FIG. 4 is not used to determine the traveling primary pressure, but the traveling primary pressure is determined to be smaller than the traveling primary pressure in the normal mode by using first reference information 10r1 described later or the like. The setting after the traveling secondary pressure in the mode is the same as that in the normal mode, but since the traveling secondary pressure is equal to or less than the traveling primary pressure, the speed of the work vehicle is limited to an upper limit speed or less regardless of the operation amount of at least one operation device (setting member 11, one or a plurality of operation levers 55) by limiting the traveling primary pressure.

Referring to FIGS. 3 and 6, the work vehicle 1 includes a hydraulic pressure sensor SP11 for detecting the hydraulic pressure of a first pilot oil passage PA11, a hydraulic pressure sensor SP12 for detecting the hydraulic pressure of a second pilot oil passage PA12, an hydraulic pressure sensor SP13 for detecting the hydraulic pressure of a third pilot oil passage PA13, and a hydraulic pressure sensor SP14 for detecting the hydraulic pressure of a fourth pilot oil passage PA14. As described above, the secondary pilot pressure output from the secondary ports of the operation valves OVA, OVB, OVC, and OVD changes in accordance with the operation position of the operation lever 55. Therefore, the hydraulic pressure sensors SP11 to SP14 are sensors for detecting the traveling secondary pressure. The hydraulic pressure sensors SP11 to SP14 may be referred to as an additional hydraulic pressure sensor.

A work vehicle 1 includes a hydraulic pressure sensor SP5L for detecting the hydraulic pressure of a drive oil passage PA5L, a hydraulic pressure sensor SP6L for detecting the hydraulic pressure in the drive oil passage PA6L, a hydraulic pressure sensor SP5R for detecting the hydraulic pressure in the drive oil passage PA5R, and a hydraulic pressure sensor SP6R for detecting the hydraulic pressure in the drive oil passage PA6R. That is, the hydraulic pressure sensors (SP5L, SP6L, SP5R, SP6R) are configured to detect the hydraulic pressure of the hydraulic fluid in the drive oil passages (PA5L, PA6L, PA5R, PA6R). The states of the first hydraulic motor 31L and the second hydraulic motor 31R can be detected from the pressure difference between the hydraulic sensor SP5L and the hydraulic sensor SP6L and the pressure difference between the hydraulic sensor SP5R and the hydraulic sensor SP6R.

Referring to FIGS. 2, 3, and 6, the work vehicle 1 includes a rotation sensor SR31L for detecting the rotational speed of the first hydraulic motor 31L and a rotation sensor SR31R for detecting the rotational speed of the second hydraulic motor 31R, which are connected to the rotational shaft of the first hydraulic motor 31L. The states of the first hydraulic motor 31L and the second hydraulic motor 31R can be detected from the magnitude of the rotational direction and rotational speed detected from the rotational sensor SR31L and the magnitude of the rotational direction and rotational speed detected from the rotational sensor SR31R. The work vehicle 1 may include an operation detection sensor 18 for detecting the operation position of the operation lever 55. The operation detection sensor 18 is connected to a controller 10 to be described later. The operation detection sensor 18 is a position sensor for detecting the position of the operation lever 55.

### <Configuration of Controller 10>

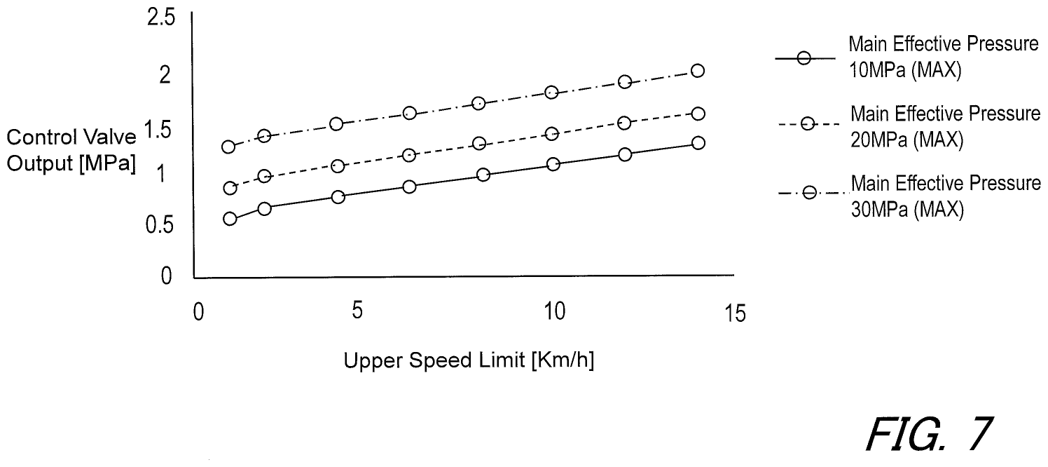

The controller 10 includes a processor 10a and a memory 10b as shown in FIG. 7 in order to realize the control of the vehicle speed in the creep mode described above. The processor 10a may be referred to as an electronic circuit (circuitry). The memory 10b includes a volatile memory and a non-volatile memory. The memory 10b includes at least a travel control program 10c1 for realizing the above-described control, first reference information 10r1, second reference information 10r2, third reference information 10r3, and fourth reference information 10r4. The first reference information 10r1 represents a first relationship between the above-mentioned upper limit speed in the creep mode, the hydraulic pressure of oil passages (CL, CR) between hydraulic motors (31L, 31R) for running the work vehicle land hydraulic pumps (7L, 7R) for running the work vehicle 1, and the traveling primary pressure of pilot oil input to the operation valves OVA, OVB, OVC, OVD corresponding to the upper limit speed and the hydraulic pressure. The hydraulic pressure of the oil passages (CL, CR) between the hydraulic motors (31L, 31R) and the hydraulic pumps (7L, 7R) is an average value of the highest hydraulic pressure and the second highest hydraulic pressure among the four hydraulic pressures of the hydraulic pressure sensor SP5L, the hydraulic pressure sensor SP6L, the hydraulic pressure sensor SP5R, and the hydraulic pressure sensor SP6R. The first reference information 10r1 represents a first relationship when the rotational speed of the engine 6 of the work vehicle 1 is the first rotational speed RS1. The first rotational speed RS1 is a standard engine rotational speed when performing the above-described anti-stall control.

FIG. 7 shows an example of the first reference information 10r1. FIG. 7 illustrates the upper limit speed set by the creep setting member 16 as the horizontal axis, the control pressure output representing the traveling primary pressure as the vertical axis, and the hydraulic pressure in the oil passages (CL, CR) between the hydraulic motors (31L, 31R) and the hydraulic pumps (7L, 7R) as the main effective pressure, in order to explain the first relationship in an easy-to-understand manner. As described above, the main effective pressure is an average value of the highest hydraulic pressure and the second highest hydraulic pressure among the four hydraulic pressures of the hydraulic pressure sensor SP5L, the hydraulic pressure sensor SP6L, the hydraulic pressure sensor SP5R, and the hydraulic pressure sensor SP6R. Although FIG. 7 is a line graph showing the relationship between the upper limit speed and the traveling primary pressure when the main effective pressures are 10 MPa, 20 MPa, and 30 MPa, the first relationship may include the relationship between the upper limit speed and the traveling primary pressure at other main effective pressures. The range which is not set as the upper limit speed is a speed range which cannot be set by the creep setting member 16.

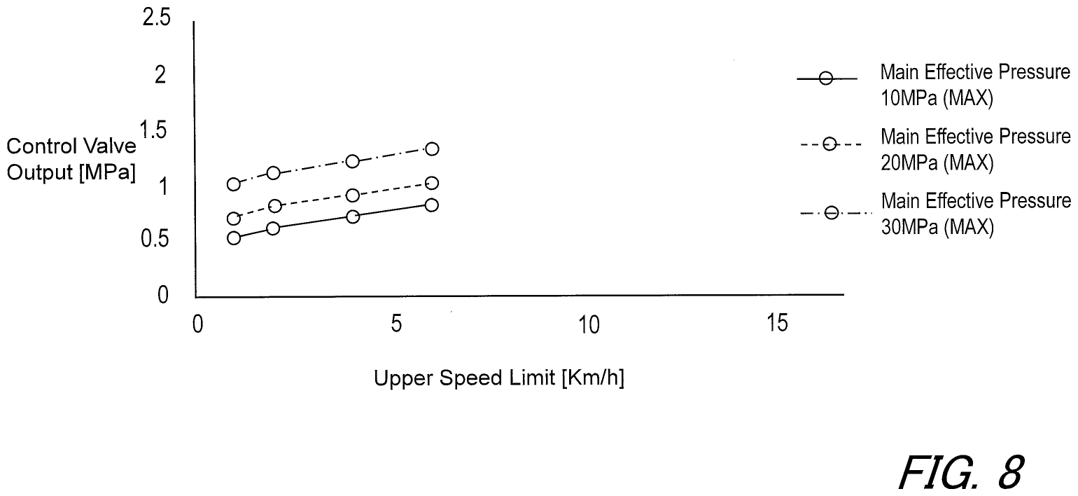

FIG. 8 shows an example of the second reference information 10r2. The second reference information 10r2 represents a second relationship between the upper limit speed, the main effective pressure, and the traveling primary pressure when the rotational speed of the engine 6 of the work vehicle 1 is a second rotational speed RS2 which is different from the first rotational speed RS1. The second rotational speed RS2 is lower than the first rotational speed RS1. The second rotational speed RS2 is, for example, an idling speed of the engine 6. The meanings of the vertical axis, the horizontal axis and the main effective pressure in FIG. 8 are the same as those in FIG. 7. Since the second rotational speed RS2 is much smaller than the first rotational speed RS1, even if the capacity of the hydraulic pumps (7L, 7R) is maximized, the maximum value of the rotational speed of the hydraulic motors (31L, 31R) is limited and the upper limit speed is limited. Therefore, the range of the upper limit speed is narrower than that in FIG. 7. When the upper limit speed set by the creep setting member 16 is out of the range represented by the second relationship, the speed control in the normal mode is performed.

The third reference information 10r3 represents a third relationship between the rotational speed RS of the engine 6 detected by the speed sensor 6a and the traveling primary pressure in the normal mode. That is, the third reference information 10r3 represents the third relationship represented by the setting line L1 in FIG. 4. The fourth reference information 10r4 represents a fourth relationship between the rotational speed RS of the engine 6 detected by the speed sensor 6a and the traveling primary pressure, which is used to control the traveling primary pressure when the drop amount of the engine 6 is large in the normal mode. That is, the fourth reference information 10r4 represents the fourth relationship represented by the setting line L2 in FIG. 4.

The processor 10a executes the following control while executing the travel control program 10c1 while referring to the first reference information 10r1, the second reference information 10r2, the third reference information 10r3, and the fourth reference information 10r4. First, when the normal mode is selected by the creep setting member 16, the processor 10a acquires the rotational speed RS of the engine 6 from the speed sensor 6a, determines traveling primary pressure corresponding to the detected rotational speed RS of the engine 6 from the third reference information 10r3, and controls a pilot pressure control valve CV1 so as to obtain the determined traveling primary pressure. When the normal mode is selected and the amount of drop of the engine 6 is large, the processor 10a is configured to obtain traveling primary pressure corresponding to the rotational speed RS of the engine 6 detected by the speed sensor 6a from the fourth reference information, and to control a pilot pressure control valve CV1 so as to obtain the obtained traveling primary pressure.

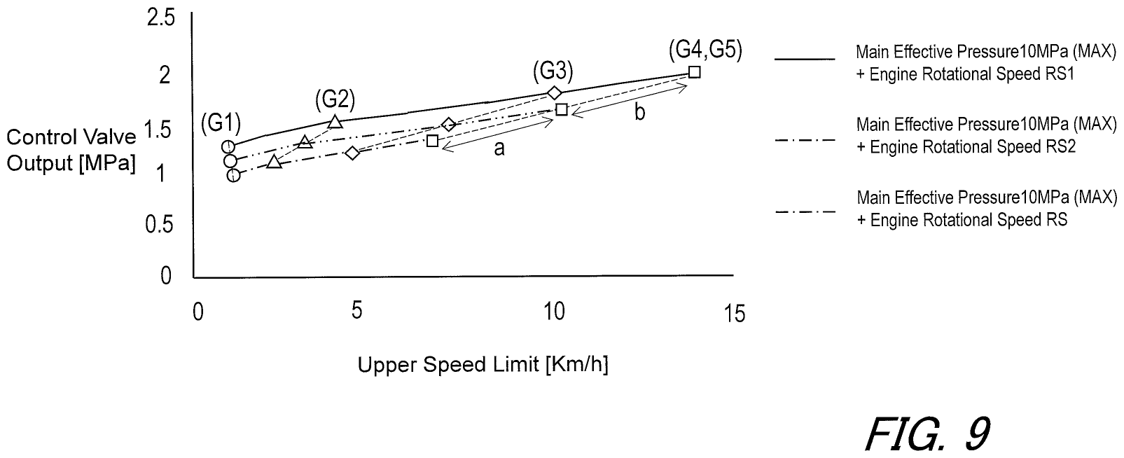

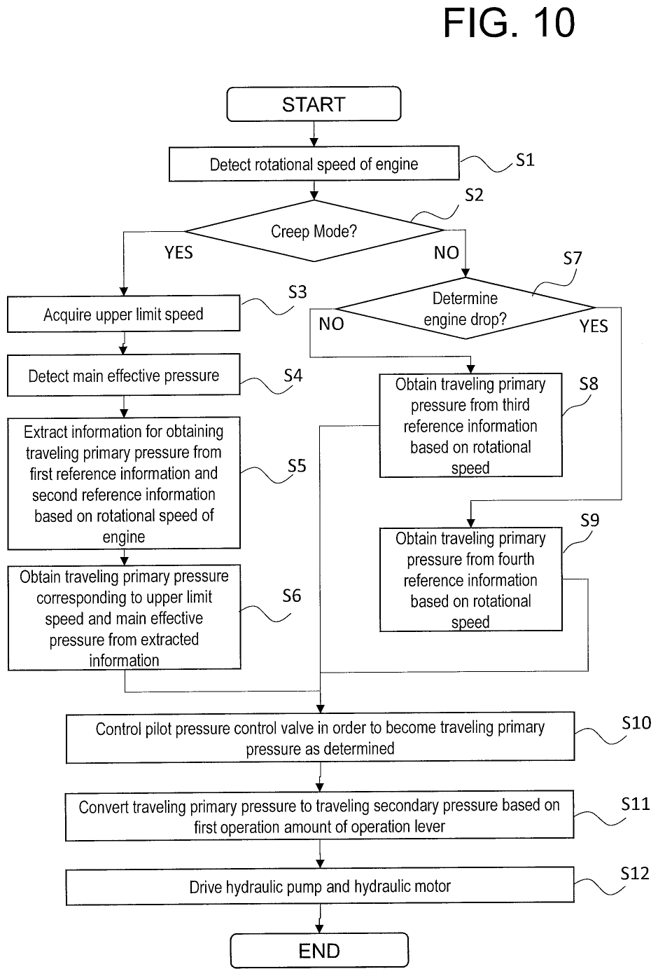

When a creep mode is selected by a creep setting member 16, a processor 10a acquires an upper limit speed inputted by the creep setting member 16, acquires a main effective pressure, acquires a rotational speed RS of an engine 6 detected by a speed sensor 6a, extracts information for obtaining traveling primary pressure from first reference information 10r1 and second reference information 10r2 on the basis of the acquired rotational speed RS, and determines traveling primary pressure on the basis of the extracted information. For example, when the absolute value of the difference between the acquired rotational speed RS and the first rotational speed RS1 is less than the threshold value, the processor 10a obtains the traveling primary pressure corresponding to the obtained upper limit speed and the obtained main effective pressure from the first reference information 10r1. When the absolute value of the difference between the acquired rotational speed RS and the second rotational speed RS2 is less than the threshold value, the processor 10a obtains the traveling primary pressure corresponding to the acquired upper limit speed and the acquired main effective pressure from the second reference information 10r2. Alternatively, linear interpolation may be used as shown in FIG. 9. The first reference information 10r1 and the second reference information 10r2 have a first relationship and a second relationship in association with the lever positions of the operation lever 55 (for example, lever operation positions G1 to G5 in FIG. 5). When the engine rotational speed RS is between the rotational speed RS1 and the rotational speed RS2, an internal dividing point at which a:b=(RS-RS2):(RS1-RS) in FIG. 10 is obtained, and a relationship between the traveling primary pressure and the upper limit speed is obtained so as to connect the internal dividing points. Further, when the acquired main effective pressure is not shown in the relationship shown in FIG. 7 or FIG. 8, the relationship for obtaining the effective primary pressure by linear interpolation or the like may be obtained based on the difference between the acquired main effective pressure and one of the main effective pressure among the first reference information 10r1 and the second reference information 10r2, and the difference between the acquired main effective pressure and another one of the main effective pressure among the first reference information 10r1 and the second reference information 10r2. Then, the processor 10a controls the pilot pressure control valve CV1 in order to become the traveling primary pressure as obtained.

### <Operation of Work Vehicle>

FIG. 10 is a flowchart showing the operation of the work vehicle 1 according to the first embodiment. In this flowchart, the processes from step S1 to step S12 are executed at predetermined sampling intervals (e.g., 20 μs). In step S1, the processor 10a acquires the rotational speed RS of the engine 6 detected by the speed sensor 6a. That is, the control method for the work vehicle 1 according to the present embodiment includes acquiring the rotational speed RS of the engine 6 detected by the speed sensor 6a. In step S2, the processor 10a determines whether or not the creep mode has been selected by the creep setting member 16. That is, the control method according to the present embodiment includes determining whether or not the creep mode has been selected by the creep setting member 16. When the creep mode is set, that is, when the upper limit speed is set (Yes in step S2), the process proceeds from step S3 to step S6. When the normal mode is set, that is, when the upper limit speed is not set, or when an invalid upper limit speed having no first correspondence or second correspondence is set (No in step S2), the process proceeds from step S7 to step S9.

In the creep mode (Yes in step S2), in step S3, the processor 10a acquires the upper limit speed input by the creep setting member 16. That is, the control method according to the present embodiment acquires the upper limit speed input by the creep setting member 16. In step S3, the processor 10a acquires the hydraulic pressures detected by the hydraulic pressure sensors SP5L, SP6L, SP5R, and SP6R, and determines a main effective pressure which is an average value of the highest hydraulic pressure and the second highest hydraulic pressure among these hydraulic pressures. That is, the control method according to the present embodiment detects the main effective pressure which is the hydraulic pressure of the oil passages (CL, CR) between the hydraulic motors (31L, 31R) for running the work vehicle 1 and the hydraulic pumps (7L, 7R) for running the work vehicle 1.

In step S5, the processor 10a extracts information for obtaining the traveling primary pressure from the first reference information 10r1 and the second reference information 10r2 based on the rotational speed RS of the engine 6. The extraction method is as described above. That is, the control method according to the present embodiment includes preparing the first reference information 10r1 and the second reference information 10r2. In step S6, the processor 10a obtains the traveling primary pressure corresponding to the upper limit speed and the main effective pressure from the extracted information. That is, the control method according to the present embodiment includes obtaining the traveling primary pressure from the first reference information 10r1 and the second reference information 10r2 based on the detected rotational speed RS, the first relationship, and the second relationship. When the absolute value of the difference between the acquired rotational speed RS and the first rotational speed RS1 is less than the threshold value, the control method according to the present embodiment includes determining the traveling primary pressure corresponding to the acquired upper limit speed and the acquired main effective pressure from the first reference information 10r1. After completion of the step S6 is completed, the process of step S10 is executed.

In step S10, the processor 10a controls the pilot pressure control valve CV1 which sends the pilot oil to the operation valves OVA, OVB, OVC, and OVD in order to become the traveling primary pressure as determined in step S6. In other words, the control method according to the present embodiment includes controlling the pilot pressure control valve CV1 that sends the pilot oil to the operation valves OVA, OVB, OVC, and OVD in order to become the traveling primary pressure as determined.

In the normal mode (Yes in step S2), in step S7, the processor 10a determines whether there is an engine drop. That is, in step S7, the processor 10a determines whether or not the drop amount ΔE1 of the engine 6 is equal to or larger than the anti-stall determination value. When there is no engine drop (No in step S7), in step S8, the processor 10a obtains the traveling primary pressure from the third reference information 10r3 based on the rotational speed RS of the engine 6. That is, in the control method according to the present embodiment, the third reference information 10r3 is prepared, and when the normal mode is selected from the creep mode and the normal mode, the traveling primary pressure corresponding to the rotational speed RS of the engine 6 detected by the speed sensor 6a is obtained from the third reference information 10r3. When there is an engine drop (Yes in step S7), in step S9, the processor 10a obtains the traveling primary pressure from the fourth reference information 10r4 based on the rotational speed RS of the engine 6. That is, in the control method according to the present embodiment, the fourth reference information 10r4 is prepared, and when the normal mode is selected and the engine drop occurs, the traveling primary pressure corresponding to the rotational speed RS of the engine 6 detected by the speed sensor 6a is obtained from the fourth reference information 10r4. After completion of the processing of step S8 or step S9, the processing of step S10 is executed.

In step S10, the processor 10a controls the pilot pressure control valve CV1 which sends the pilot oil to the operation valves OVA, OVB, OVC, and OVD so as to obtain the traveling primary pressure determined in step S8 or step S9. In other words, the control method according to the present embodiment includes controlling the pilot pressure control valve CV1 that sends the pilot oil to the operation valves OVA, OVB, OVC, and OVD so as to obtain the traveling primary pressure as determined. In step S11, the operation valves OVA, OVB, OVC, and OVD convert the traveling primary pressure to the traveling secondary pressure based on the lever position (first operation amount) of the operation lever 55 (first operation device 56). That is, the control method according to the present embodiment includes converting the traveling primary pressure into the traveling secondary pressure based on the lever position (first operation amount) of the operation lever 55 (first operation device 56) by the operation valves OVA, OVB, OVC, and OVD.

In step S12, the traveling secondary pressure of the pilot oil is applied to the ports (PLa, PRa, PLb, PRb) that provide hydraulic pressure to the swash plate of the hydraulic pumps (7L, 7R). A control method according to the present embodiment includes applying a traveling secondary pressure of the pilot oil to ports (PLa, PRa, PLb, PRb) that provide hydraulic pressure to a swash plate of hydraulic pumps (7L, 7R).

### Operation and Effect of First Embodiment

In a method for controlling a work vehicle or a work vehicle according to a first embodiment, a processor 10a acquires an upper limit speed inputted by a creep setting member 16, acquires a main effective pressure, determines traveling primary pressure corresponding to the acquired upper limit speed and the main effective pressure from first reference information 10r1, and controls a pilot pressure control valve CV1 for sending the pilot oil to operation valves OVA, OVB, OVC, OVD so as to obtain the traveling primary pressure as determined. By feedback control using fluctuation of main effective pressure, it is possible to realize improvement of response in the creep mode.

### Second Embodiment

In the first embodiment, the same traveling primary pressure is calculated as the traveling primary pressure in the creep mode regardless of whether or not the work vehicle 1 is turning. However, the larger the curvature in which the work vehicle 1 turns (the smaller the turning radius), the larger the running resistance received by the work vehicle 1 from the ground becomes, so that the traveling primary pressure required to turn at the desired upper limit speed becomes larger. A processor 10a according to a second embodiment obtains a straight-ahead degree corresponding to the turning radius of a work vehicle 1, and changes the value of traveling primary pressure corresponding to the same upper limit speed and the same main effective pressure in a first relationship on the basis of the difference between the straight-ahead degree as obtained and the straight-ahead degree serving as a reference.

First, the concept of the straight-ahead degree described above will be described. The state in which the straight-ahead degree is high is a state in which following two conditions (1 and 2) are satisfied. 1: the pilot pressure applied to ports (first port PLa third port PRa) for allowing the output shaft of a first hydraulic pump 7L and the output shaft of a second hydraulic pump 7R to rotate forward is sufficiently higher than the pilot pressure applied to ports (second port PLb, fourth port PRb) for reversing the output shaft of the first hydraulic pump 7L and the output shaft of the second hydraulic pump 7R; or the pilot pressure applied to ports (second port PLb, fourth port PRb) for reversing the output shaft of the first hydraulic pump 7L and the output shaft of the second hydraulic pump 7R is sufficiently higher than the pilot pressure applied to ports (first port PLa, third port PRa) for allowing the output shaft of the first hydraulic pump 7L and the output shaft of the second hydraulic pump 7R to rotate forward, and 2: the pilot pressures of the two ports determined to have high pilot pressures in 1 as described above are substantially equal (the value of the ratio of the two pilot pressures is within a predetermined range close to 1 (for example, between 0.9 and 1/0.9)).

Therefore, the straight-ahead degree is obtained by the following algorithm. The first pilot pressure applied to the first port PLa (pressure value of the hydraulic pressure sensor SP11) is referred to as lf(t), a second pilot pressure applied to the second port PLb (pressure value of the hydraulic pressure sensor SP12) is referred to as lb(t), a third pilot pressure applied to the third port PRa (pressure value of the hydraulic pressure sensor SP12) is referred to as rf(t), and a fourth pilot pressure applied to the fourth port PRb (pressure value of the hydraulic sensor SP14) is referred to as rb(t). First, it is determined which of lf(t)/rf(t) and lb(t)/rb(t) is within a predetermined range close to 1 (for example, between 0.9 and 1/0.9). When it is determined that lf(t)/rf(t) is within the predetermined range, the larger value from if (t) or rf(t) is substituted into the variable PV_{Bstraight}.

If a value is assigned to PV_{Fstraight}, the straight-ahead degree S_{Fratio}(t) in the forward direction is obtained by equation (1). When a value is substituted for PV_{Bstraight}, the straight-ahead degree S_{Bratio}(t) in the backward direction is obtained by equation (2).

S_{Fratio}(t)={lf(t)+rf(t)}/{2×PV_{Fstraight}} (1)

S_{Bratio}(t)={lb(t)+rb(t)}/{2×PV_{Bstraight}} (2)

Here, the larger value from S_{Fratio}(t) and S_{Bratio}(t) is calculated as straight-ahead degree by the processor 10a.

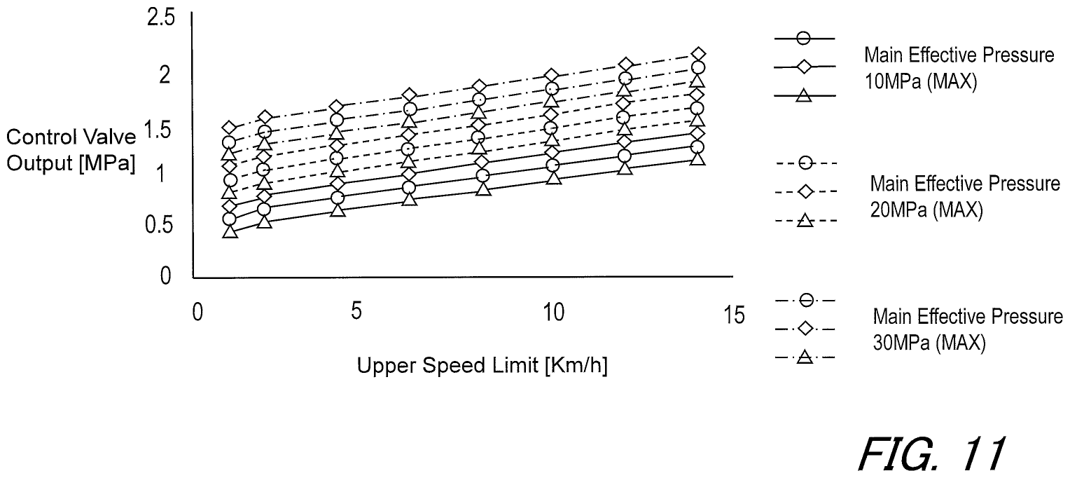

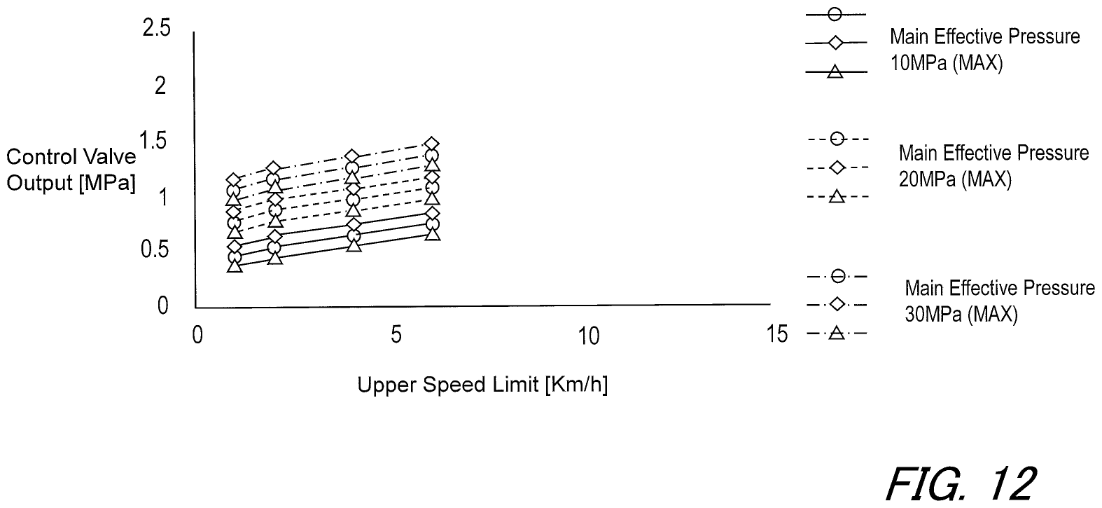

In the present embodiment, for example, when 300, which can be generally regarded as straight-ahead, is set as the reference straight-ahead degree, and when the straight-ahead degree is equal to or greater than the reference straight-ahead degree, the traveling primary pressure is obtained using the relationship marked with a circle in FIGS. 11 and 12. The traveling primary pressure is obtained by using a relationship (relationship marked with a diamond) in which the traveling primary pressure becomes larger than the relationship marked with a circle as the straight-ahead degree becomes smaller from the reference straight-ahead degree.

Alternatively, when the intermediate value 150 is the reference straight-ahead degree and the straight-ahead degree is the reference straight-ahead degree (150), the traveling primary pressure may be determined using the relationship marked with a circle in FIGS. 11 and 12. The traveling primary pressure may be obtained by using a relationship (relationship marked with a diamond) in which the traveling primary pressure becomes larger than the relationship marked with a circle as the straight-ahead degree obtained in the above (1) or (2) becomes smaller than the reference straight-ahead degree. Further, the traveling primary pressure may be obtained by using a relationship (relationship marked with a triangle) in which the traveling primary pressure becomes smaller than the relationship marked with a circle as the straight-ahead degree obtained in the above (1) or (2) becomes larger than the reference straight-ahead degree.

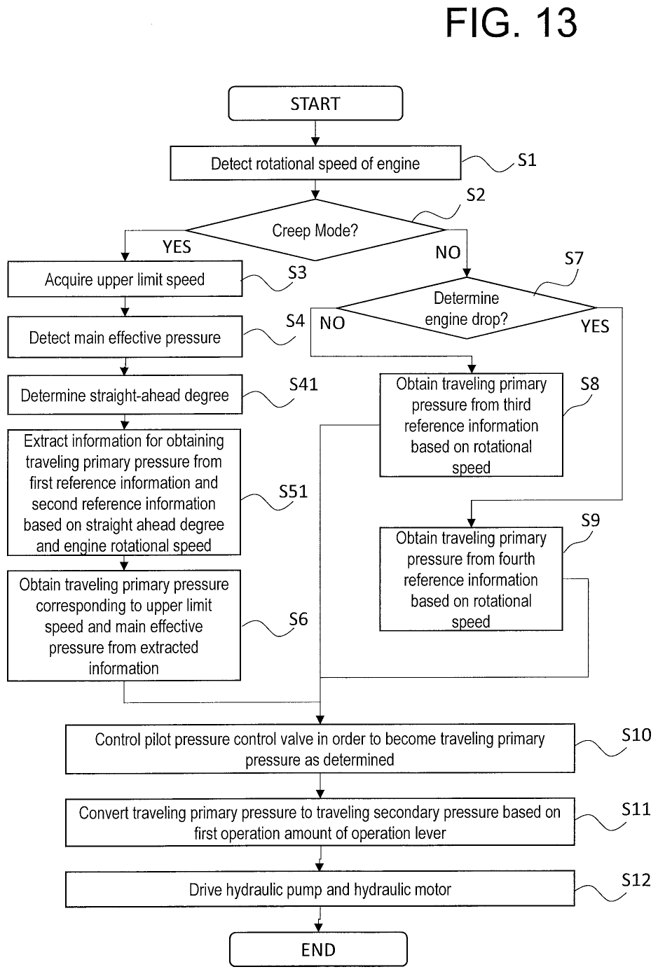

FIG. 13 is a flowchart showing the operation of the work vehicle 1 according to the second embodiment. Here, the same operations as those of the first embodiment are denoted by the same reference numerals, and detailed description thereof is omitted. In the work vehicle 1 according to the present embodiment, after step S4, in step S41, the hydraulic pressure sensors SP11 to SP14 detect the traveling secondary pressure. The processor 10a acquires the pressure values of the hydraulic pressure sensors SP11 to SP14, and calculates the straight-ahead degree based on the above-described algorithm. That is, in step S41, the control method according to the present embodiment includes detecting the traveling secondary pressure by the hydraulic pressure sensors SP11 to SP14 and determining the straight-ahead degree.

Next, in step S51 instead of step S5 of the first embodiment, the processor 10a changes the value of the traveling primary pressure corresponding to the same upper limit speed and the same main effective pressure in the first relationship based on the difference between the obtained straight-ahead degree and the reference straight-ahead degree. The processor 10a changes the value of the traveling primary pressure corresponding to the same upper limit speed and the same main effective pressure in the second relationship based on the difference between the obtained straight-ahead degree and the reference straight-ahead degree. That is, the processor 10a corrects the first relationship and the second relationship read from the first reference information 10r1 and the second reference information 10r2 in accordance with the straight-ahead degree as in the above-described algorithm. Then, based on the corrected first relationship and second relationship, the traveling primary pressure is obtained by the same method as that of the first embodiment.

In other words, the control method according to the present embodiment changes the value of the traveling primary pressure corresponding to the same upper limit speed and the same main effective pressure in the first correspondence by changing the value of the traveling primary pressure corresponding to the same upper limit speed and the same main effective pressure in the first correspondence based on the difference between the obtained straight-ahead degree and the reference straight-ahead degree. The control method according to the present embodiment changes the value of the traveling primary pressure corresponding to the same upper limit speed and the same main effective pressure in the second relationship based on the difference between the obtained straight-ahead degree and the reference straight-ahead degree. That is, the control method according to the present embodiment corrects the first relationship and the second relationship read from the first reference information 10r1 and the second reference information 10r2 in accordance with the straight-ahead degree as in the above-described algorithm. Then, based on the corrected first relationship and second relationship, the traveling primary pressure is obtained by the same method as that of the first embodiment.

### Operation and Effect of Second Embodiment

In a control method for a work vehicle or a work vehicle according to a second embodiment, hydraulic pressure sensors (SP11 to SP14) detect a traveling secondary pressure, a processor 10a obtains a straight-ahead degree from the traveling secondary pressure, and changes the value of the traveling primary pressure corresponding to the same upper limit speed and the same main effective pressure in a first relationship and a second relationship based on the difference between the obtained straight-ahead degree and a reference straight-ahead degree. Therefore, when the straight-ahead degree, which increases the running resistance received by the work vehicle 1 from the ground, is small, the traveling primary pressure can be increased, so that the work vehicle 1 can turn at the upper limit speed which is close to the speed desired by the operator.

### Third Embodiment

In the first embodiment and the second embodiment, the moving speed of the work vehicle 1 is controlled without using the rotational speed of the output of the hydraulic motors (31L, 31R), but by feeding back the rotational speed of the output of the hydraulic motors (31L, 31R), it is possible to run the work vehicle 1 at an upper limit speed which is closer to the speed desired by the operator. The creep mode is used to enable the user to operate the work vehicle 1 at a lever position (G4 to G5 in FIG. 5) which is easy to operate when moving the work vehicle 1 in a speed range (for example, the lever operation positions G1 to G4 in FIG. 5) having a delicate operation in the normal mode. Accordingly, the following control is carried out on the assumption of the traveling secondary pressure being equal to the traveling primary pressure.

When the rotational speed of the output of hydraulic motors (31L, 31R) is detected from rotation sensors SR31L, SR31R, the actual vehicle speed of the work vehicle can be calculated from the reduction ratio of the reduction gear connected to the first hydraulic motor 31L, the reduction ratio of the reduction gear connected to the second hydraulic motor 31R, and the shape of the traveling device 3. When the actual vehicle speed and the upper limit speed set by the creep setting member 16 are equal to each other, the traveling primary pressure is obtained by using the relationship marked with a circle in FIGS. 11 and 12. As the actual vehicle speed is smaller than the upper limit speed, the traveling primary pressure is obtained by using the relationship (relationship marked with a diamond) in which the traveling primary pressure becomes larger than the relationship marked with a circle in FIGS. 11 and 12. On the other hand, as the actual vehicle speed is larger than the upper limit speed, the traveling primary pressure is obtained using the relationship (relationship marked with a triangle) in which the traveling primary pressure becomes smaller than the relationship marked with a circle in FIGS. 11 and 12.

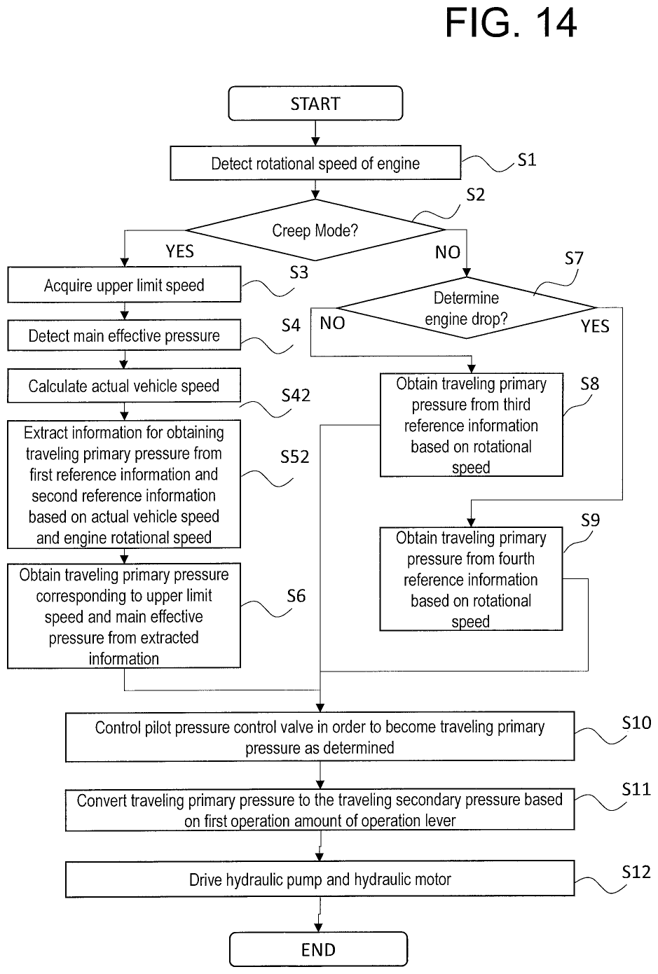

FIG. 14 is a flowchart showing the operation of the work vehicle 1 according to the third embodiment. Here, the same operations as those of the first embodiment are denoted by the same reference numerals, and detailed description thereof is omitted. In the work vehicle 1 according to the present embodiment, after step S4, in step S42, the rotational speed of the output of the hydraulic motors (31L, 31R) is detected from the rotation sensors SR31L and SR31R. The processor 10a acquires the rotational speed of the output of the hydraulic motors (31L, 31R) from the rotation sensors SR31L and SR31R, and determines the actual vehicle speed. That is, the control method according to the present embodiment includes obtaining the actual vehicle speed from the rotational speed in step S42.

Next, in step S52 instead of step S5 of the first embodiment, the processor 10a changes the value of the traveling primary pressure corresponding to the same upper limit speed and the same main effective pressure in the first relationship based on the difference between the obtained actual vehicle speed and the upper limit speed. The processor 10a changes the value of the traveling primary pressure corresponding to the same upper limit speed and the same main effective pressure in the second relationship based on the difference between the actual vehicle speed and the upper limit speed. In other words, the processor 10a corrects the first relationship and the second relationship read from the first reference information 10r1 and the second reference information 10r2 according to the difference between the actual vehicle speed and the upper limit speed as in the above-described algorithm. Then, based on the corrected first relationship and second relationship, the traveling primary pressure is obtained by the same method as that of the first embodiment.

In other words, the control method according to the present embodiment changes the value of the traveling primary pressure corresponding to the same upper limit speed and the same main effective pressure in the first relationship based on the difference between the actual vehicle speed and the upper limit speed. The control method according to the present embodiment changes the value of the traveling primary pressure corresponding to the same upper limit speed and the same main effective pressure in the second relationship based on the difference between the actual vehicle speed and the upper limit speed. That is, the control method according to the present embodiment corrects the first relationship and the second relationship read from the first reference information 10r1 and the second reference information 10r2 in accordance with the difference between the actual vehicle speed and the upper limit speed as in the above-described algorithm. Then, based on the corrected first relationship and second relationship, the traveling primary pressure is obtained by the same method as that of the first embodiment.

### Operation and Effect of Third Embodiment

In a control method for a work vehicle 1 or a work vehicle 1 according to a third embodiment, rotation sensors SR31L and SR31R detect the rotational speed of the output of hydraulic motors (31L, 31R), and a processor 10a obtains an actual vehicle speed from the rotational speed, and the obtained actual vehicle speed and a setting are performed based on the deviation from the upper limit speed set by the creep setting member 16, the value of the traveling primary pressure corresponding to the same upper limit speed and the same hydraulic pressure in the first correspondence and the second correspondence is changed. Therefore, by feeding back the rotational speed of the output of the hydraulic motors (31L, 31R), the work vehicle can turn at an upper limit speed close to the speed desired by the operator.

### Modified Example

In the work vehicle 1 which does not include the second embodiment, the hydraulic pressure sensors SP11, SP12, SP13, and SP14 may be omitted. In the second embodiment, the straight-ahead degree may be calculated from the output values of the hydraulic pressure sensors SP5L, SP6L, SP5R, and SP6R. In the work vehicle 1 which does not include the third embodiment, the rotation sensors SR31L and SR31R may be omitted.

Although the above-described embodiment shows the case where there are two reference information, i.e., the first reference information 10r1 and the second reference information 10r2, the third reference information 10r3 corresponding to different engine rotational speeds may be included and controlled as described above. Further, the second reference information 10r2 may be omitted.

The first pilot pressure applied to the first port PLa, the second pilot pressure applied to the second port PLb, the third pilot pressure applied to the third port PRa, and the fourth pilot pressure applied to the fourth port PRb are not limited to being controlled by controlling the primary pilot pressure input to the operation device 56, but the secondary pilot pressure output from the operation device 56 may be directly controlled according to the moving state.

The values of the various threshold values may be changed according to characteristics of the first hydraulic pump 7L, the second hydraulic pump 7R, the first hydraulic motor 31L, and the second hydraulic motor 31R, a reduction gear connected to the first hydraulic motor 31L, a reduction gear connected to the second hydraulic motor 31R, and characteristics of various control valves.

In the present application, “comprising” and derivatives thereof are non-limiting terms describing the presence of an element and do not exclude the presence of other elements not described. This also applies to “have,” “include,” and derivatives thereof.

The terms “member”, “part”, “element”, “body”, and “structure” may have multiple meanings, such as a single part or a plurality of parts.

Ordinal numbers such as “first” and “second” are merely terms used to identify the structure and have no other meaning (e.g., a particular order). For example, the existence of the “first element” does not imply the existence of the “second element”, and the existence of the “second element” does not imply the existence of the “first element”.

Terms such as “substantially”, “about”, and “approximately” to indicate the degree may mean a reasonable amount of deviation such that the final result does not change significantly, unless otherwise stated in the embodiments. All numerical values set forth herein may be construed to include words such as “substantially”, “about”, and “approximately”.

In this application, the phrase “at least one of A and B” should be interpreted to include only A, only B, and both A and B.

In view of the above disclosure, it is apparent that various modifications and modifications of the present invention are possible. RU. Accordingly, the present invention may be carried out by a method different from the specific disclosure of the present application without departing from the spirit of the present invention.

What is claimed is:

1. A control method for a work vehicle, the control method comprising:
acquiring an upper limit speed in a creep mode in which the work vehicle travels at the upper limit speed or less regardless of an operation amount of at least one operation device to receive a speed alteration operation from a user;
detecting a hydraulic pressure in an oil passage between a hydraulic motor to move the work vehicle and a hydraulic pump to actuate the hydraulic motor;
determining a traveling primary pressure of pilot oil supplied to an operation valve operated by a first operation device out of the at least one operation device based on a first relationship among the upper limit speed, the hydraulic pressure, and the traveling primary pressure; and
controlling a control valve via which the pilot oil is supplied to the operation valve such that a pressure of the pilot oil supplied to the operation valve approaches the traveling primary pressure.

2. The control method according to claim 1, further comprising:
detecting a rotational speed of the engine; and
obtaining the traveling primary pressure based on the rotational speed of the engine, the first relationship, and a second relationship among the upper limit speed, the hydraulic pressure, and the traveling primary pressure corresponding to a second rotational speed of the engine, the traveling primary pressure in the first relationship corresponding to a first rotational speed of the engine which is different from the second rotational speed of the engine.

3. The control method according to claim 1, further comprising:
selecting a normal mode in which the speed of the work vehicle is changed in accordance with the operation amount of the at least one operation device;
detecting the rotational speed of the engine; and
obtaining the traveling primary pressure corresponding to the rotational speed of the engine based on a third relationship between the rotation speed of the engine and the traveling primary pressure in the normal mode.

4. The control method according to claim 3, wherein
the work vehicle is configured to travel at speed higher than the upper limit speed in the normal mode.

5. The control method according to claim 1, further comprising:
converting the traveling primary pressure into a traveling secondary pressure via the operation valve based on a first operation amount of the first operation device; and
applying the traveling secondary pressure of the pilot oil to a swash plate of the hydraulic pump.

6. The control method according to claim 5, wherein
the operation valve converts the traveling primary pressure into the traveling secondary pressure equal to the traveling primary pressure when the first operation amount is equal to or greater than the threshold amount.

7. The control method according to claim 5, further comprising:
detecting the traveling secondary pressure;
determining a straight-ahead degree corresponding to a turning radius of the work vehicle based on the traveling secondary pressure; and
changing a correlation between the traveling primary pressure and the upper limit speed in the first relationship and a correlation between the traveling primary pressure and the hydraulic pressure in the first relationship based on a difference between the straight-ahead degree and a reference straight-ahead degree.

8. The control method according to claim 1, further comprising:
detecting a rotational speed of the hydraulic motor by a rotation sensor connected to a rotational shaft of the hydraulic motor;
obtaining an actual vehicle speed of the work vehicle from the rotational speed of the hydraulic motor; and
changing a correlation between the traveling primary pressure and the upper limit speed in the first relationship and a correlation between the traveling primary pressure and the hydraulic pressure in the first relationship based on a difference between the actual vehicle speed and the upper limit speed.

9. A work vehicle comprising:
a hydraulic motor configured to drive a traveling device;
a hydraulic pump configured to discharge a hydraulic fluid to drive the hydraulic motor;
an oil passage connecting the hydraulic pump and the hydraulic motor;
a hydraulic pressure sensor configured to detect a hydraulic pressure of hydraulic fluid in the oil passage;
at least one operation device to receive a speed alteration operation from a user, the at least one operation device including a first operation device;
a pilot pump configured to discharge pilot oil;
a pilot oil passage connecting the pilot pump and the hydraulic pump;
an operation valve provided in the pilot oil passage and configured to convert a pressure of the pilot oil from a traveling primary pressure to a traveling secondary pressure according to a first operation amount of the first operation device;
a control valve provided in the pilot oil passage between the pilot pump and the operation valve to convert a pressure of the pilot oil supplied by the pilot pump into the traveling primary pressure;
an input device configured to receive an upper limit speed and to set a creep mode in which the traveling device travels at the upper limit speed or less regardless of an operation amount of the at least one operation device;
a memory configured to store a first relationship among the upper limit speed, the hydraulic pressure of the hydraulic fluid, and the traveling primary pressure; and
a processor configured to
acquire the upper limit speed from the input device,
determine the traveling primary pressure corresponding to the hydraulic pressure detected by the hydraulic pressure sensor and the upper limit speed received by the input device based on the first relationship, and
control the control valve such that a pressure of the pilot oil supplied to the operation valve approaches the traveling primary pressure.

10. The work vehicle according to claim 9, comprising:
a speed sensor configured to detect a rotational speed of the engine,
wherein the memory further stores a second relationship among the upper limit speed, the hydraulic pressure, and the traveling primary pressure corresponding to a second rotational speed of the engine, the traveling primary pressure in the first relationship corresponding to a first rotational speed of the engine which is different from the second rotational speed of the engine, and
wherein the processor is configured to obtain the traveling primary pressure based on the rotational speed of the engine, the first relationship, and the second relationship.

11. The work vehicle according to claim 9, further comprising:
a speed sensor configured to detect the rotational speed of the engine,
wherein the input device is configured to select the creep mode and a normal mode alternatively, the speed of the work vehicle being changed in accordance with the operation amount of the at least one operation device in the normal mode, the work vehicle being configured to travel at a speed greater than the upper limit speed in the normal mode,
wherein the memory is configured to store a third relationship between the rotational speed of the engine and the traveling primary pressure in the normal mode, and
wherein, when the normal mode is selected by the input device, the processor is configured to obtain the traveling primary pressure corresponding to the rotational speed of the engine based on the third relationship.

12. The work vehicle according to claim 9,
wherein the operation valve converts the traveling primary pressure into the traveling secondary pressure based on the first operation amount, and
wherein the traveling secondary pressure of the pilot oil is applied to a swash plate of the hydraulic pump.

13. The work vehicle according to claim 12,
wherein, when the first operation amount is equal to or greater than the threshold amount, the operation valve converts the traveling primary pressure to the traveling secondary pressure equal to the traveling primary pressure.

14. The work vehicle according to claim 12, further comprising:
an additional pressure sensor configured to detect the traveling secondary pressure,
wherein the processor is configured to determine a straight-ahead degree corresponding to a turning radius of the work vehicle based on the traveling secondary pressure detected by the additional pressure sensor, and configured to change a correlation between the traveling primary pressure and the upper limit speed in the first relationship and a correlation between the traveling primary pressure and the hydraulic pressure in the first relationship based on a difference between the straight-ahead degree and a reference straight-ahead degree.

15. The work vehicle according to claim 9, further comprising:
a rotation sensor connected to a rotational shaft of the hydraulic motor and configured to detect a rotational speed of the hydraulic motor,
wherein the processor is configured to obtain an actual vehicle speed of the work vehicle from the rotational speed of the hydraulic motor and change a correlation between the traveling primary pressure and the upper limit speed in the first relationship and a correlation between the traveling primary pressure and the hydraulic pressure in the first relationship based on a difference between the actual vehicle speed and the upper limit speed.

16. A control device for a work vehicle, the control device comprising:
a processor configured to
acquire an upper limit speed in a creep mode in which the work vehicle travels at upper limit speed or less regardless of an operation amount of at least one operation device to receive a speed alteration operation from a user,
acquire a hydraulic pressure in an oil passage between a hydraulic motor to move the work vehicle and a hydraulic pump to actuate the hydraulic motor,
determine a traveling primary pressure of pilot oil supplied to an operation valve operated by a first operation device out of the at least one operation device based on a first relationship among the upper limit speed, the hydraulic pressure, and the traveling primary pressure, and
control a control valve via which the pilot oil is supplied to the operation valve such that a pressure of the pilot oil supplied to the operation valve approaches the traveling primary pressure; and
a memory configured to store the first relationship.
